(19) United States
(12) Patent Application Publication
(10) Pub. No.: US 2006/0092462 A1
(43) Pub. Date: May 4, 2006

(54) Printing management device, printing-management-feature-provided printing device, printing-management-feature-provided information processor, printing system, printing device, printing management program, printing-management- feature-provided printing device control program, printing-management-feature-provided information processor control program, printing device control program, printing management method, printing-management-feature-provided printing device control method, printing-management-feature-provided information processor control method, and printing device control method.

(75) Inventor: Senichi Mokuya, Suwa (JP)

Correspondence Address: HARNESS, DICKEY & PIERCE, P.L.C., P.O. BOX 828, BLOOMFIELD HILLS, MI, 48303, US

(73) Assignee: Seiko Epson Corporation

(21) Appl. No.: 11/262,348

(22) Filed: Oct. 28, 2005

(30) Foreign Application Priority Data
Oct. 29, 2004 (JP) 2004-315335
Aug. 15, 2005 (JP) 2005-235259

(51) Int. Cl. G06F 3/12

(52) U.S. Cl. 358/1.15

(57) ABSTRACT

A printing management device that determines allocation details for a printing process in a system including a plurality of printing devices that execute the printing process based on printing data.

### RELATED APPLICATIONS

This application claims priority to Japanese patent application Nos. 2004-315335 filed Oct. 29, 2004 and 2005-235259 field Aug. 15, 2005 which are hereby expressly incorporated by reference in their entirety.

### BACKGROUND

1. Technical Field

The present invention relates to a printing management device, a printing-management-feature-provided printing device, a printing-management-feature-provided information processor, a printing system, a printing device, a printing management program, a printing-management-feature-provided printing device control program, a printing-management-feature-provided information processor control program, a printing device control program, a printing management method, a printing-management-feature-provided printing device control method, a printing-management-feature-provided information processor control method, and a printing device control method, all of which are suitable for allocating and distributing, while a printing process is in progress, any not-yet-processed part of printing data to any other arbitrary printing devices for processing therein.

2. Related Art

When a user prints a document using a printer, once the printing process is started, the not-yet-completed part of the printing process is generally not allowed to be allocated and distributed to any other arbitrary printer while the process is in progress.

However, Patent Document 1 (JP-A-2001-290630) describes a printing device that allocates and distributes a printing process among a plurality of printer devices.

The process-distributing printing device of Patent Document 1 includes a plurality of printers for process distribution thereamong. Assume that an error occurs to any one of such distribution-designated printers after output of printing data but before completion of printing. In such a case, for a substitution of the error-inflicted printer, the printing device searches the distribution-designated printers other than the error-inflicted printer to find an available printer that is not currently in operation. The thus found printer is put in charge of the printing process.

The process-distributing printing device of Patent Document 1 executes the printing process, without interruption, by searching for a substitute printer when an error occurs. The problem with such a device is that, once a printing process is started with an originally-designated printer, even if there is another available printer currently not in operation, the user cannot put that printer in charge of the printing process, i.e., the not-yet-completed part of the process for parallel processing. As such, with the printing device of Patent Document 1, other printers cannot be put to effective use even if they are available, and thus the printing efficiency is not high.

### SUMMARY

An advantage of some aspects of the invention is to provide a printing management device, a printing-management-feature-provided printing device, a printing-management-feature-provided information processor, a printing device, a printing management program, a printing-management-feature-provided printing device control program, a printing-management-feature-provided information processor control program, a printing device control program, a printing management method, a printing-management-feature-provided printing device control method, a printing-management-feature-provided information processor control method, and a printing device control method, all of which are suitable for allocating and distributing, while a printing process is in progress, any not-yet-processed part of printing data to any other arbitrary printing devices for processing therein.

### First Aspect

A first aspect of the invention is directed to a printing management device that determines allocation details for a printing process in a system including a plurality of printing devices that execute the printing process based on printing data. The printing management device includes:

an allocation request information acquisition unit that acquires allocation request information for the printing process, including information for specifying the printing data, and information about an allocation destination of the printing process;

a printing process status information acquisition unit that acquires, from any of the printing devices being in the printing process for the printing data, printing process status information that indicates the printing process status of the printing data;

an allocation printing data acquisition unit that acquires printing data corresponding to the allocation request information;

an allocation details determination unit that determines allocation details for the not-yet-completed part of the printing process based on the allocation request information and the printing process status information;

a printing data manipulation unit that manipulates the printing data derived by the allocation printing data acquisition unit based on the allocation details determined by the allocation details determination unit; and

a manipulated printing data transmission unit that transmits manipulated printing data as a result of manipulation of the printing data by the printing data manipulation unit to any of the printing devices being an allocation destination of the manipulated printing data.

With such a configuration, the allocation request information acquisition unit acquires allocation request information about a printing process, including information for specifying printing data, and information about an allocation destination of the printing process. After the printing request information is acquired, the printing process status information acquisition unit acquires, from any of the printing devices that is currently executing the printing process for the printing data, printing process status information that indicates the printing process status of the printing data. The allocation printing data acquisition unit acquires printing data corresponding to the allocation request information. After the allocation request information and the printing process status information are acquired, based on such information, the allocation details determination unit determines allocation details for the not-yet-completed part of the printing process. Once the allocation details are determined as such, based thereon, the printing data manipulation unit manipulates the printing data acquired by the allocation printing data acquisition unit. After the printing data is manipulated, the manipulated printing data transmission unit transmits manipulated printing data as a result of manipulation of the printing data by the printing data manipulation unit to any of the printing devices being an allocation destination of the manipulated printing data.

As such, the printing process status information can be used as a basis to determine the allocation details for the not-yet-completed part of the printing process. This allows allocating and distributing any remaining printing process to any other arbitrary printing devices even if the printing process is in progress.

The printing data is in the form of files including document files, image files, and others, created by document editors, image editors, and others, or intermediate files that are derived by describing such document files and image files in intermediate language, e.g., page description language such as PDL. Accordingly, the printing process to be executed in the printing device is not limited to a process of printing letters and pictures on printing materials, e.g., paper, surfaces of CDs or DVD media, and others, based on the printing data. The printing process also includes a process of converting document files and image files into intermediate language in description, a rendering process of converting intermediate files into image data for printing, e.g., bit map data, or others. This is applicable in the following to a printing-management-feature-provided printing device of a sixth aspect, a printing-management-feature-provided information processor of an eleventh aspect, a printing system of a seventeenth aspect, a printing management program of a twenty-fifth aspect, a printing-management-feature-provided printing device control program of a thirtieth aspect, a printing-management-feature-provided information processor control program of a thirty-sixth aspect, a printing management method of a forty-third aspect, a printing-management-feature-provided printing device control method of a forty-eighth aspect, and a printing-management-feature-provided information processor control method of a fifty-fourth aspect.

The information for specifying the printing data denotes information for use to specify which printing data is to be subjected to a printing process. The printing management device uses the information as a basis to specify which printing data is to be subjected to process allocation and distribution. In the following, this is applicable to the printing-management-feature-provided printing device of the sixth aspect, the printing-management-feature-provided information processor of the eleventh aspect, the printing system of the seventeenth aspect, the printing management program of the twenty-fifth aspect, the printing-management-feature-provided printing device control program of the thirtieth aspect, the printing-management-feature-provided information processor control program of the thirty-sixth aspect, the printing management method of the forty-third aspect, the printing-management-feature-provided printing device control method of the forty-eighth aspect, and the printing-management-feature-provided information processor control method of the fifty-fourth aspect.

The process of manipulating the printing data includes a process of changing the details of the printing data specifically in the header part based on the determined allocation details, or any other processes. The data manipulation as such is aimed to make the printing device(s) being the allocation destination go through the not-yet-completed part of the printing process. This is applicable in the following to the printing-management-feature-provided printing device of the sixth aspect, the printing-management-feature-provided information processor of the eleventh aspect, the printing system of the seventeenth aspect, the printing management program of the twenty-fifth aspect, the printing-management-feature-provided printing device control program of the thirtieth aspect, the printing-management-feature-provided information processor control program of the thirty-sixth aspect, the printing management method of the forty-third aspect, the printing-management-feature-provided printing device control method of the forty-eighth aspect, and the printing-management-feature-provided information processor control method of the fifty-fourth aspect.

### Second Aspect

According to a printing management device of a second aspect, in the first aspect,

the printing data is uniquely correlated with first personal identification information,

the allocation request information includes second personal identification information that is unique thereto, and correlated with the first personal identification information,

an allocation details determination process execution decision unit is provided for making a decision whether or not to subject the allocation details to a determination process based on the first and second personal identification information, and

when the allocation details determination process execution decision unit decides to subject the allocation details to the determination process, the allocation details determination unit executes the determination process.

With such a configuration, the allocation details determination process execution decision unit makes a decision whether or not to subject the allocation details to a determination process. Such a decision is made based on the first personal identification information that is correlated with the printing data, and the second personal identification information found in the allocation request information. When the determination process is determined as to be executed, the allocation details determination unit accordingly executes the determination process for the allocation details.

As such, the printing process is not allocated nor distributed until an allocation request is received together with appropriate personal identification information. This works well specifically when confidential documents are printed, and no third parties are allowed to issue an allocation request without the user's permission at his or her intended timing so that the confidential documents can be safely protected from stealing or peeking.

Herein, the first personal identification information uniquely determines the corresponding printing data. The second personal identification information is unique thereto, and is corresponding to the first personal identification information, i.e., the second personal identification information uniquely determines the corresponding allocation request information and is corresponding to the printing data correlating with the first personal identification information. That is, such first and second personal identification information can be used as a basis to uniquely determine any corresponding printing data. This is applicable in the following to a printing-management-feature-provided printing device of a seventh aspect, a printing-management-feature-provided information processor of a twelfth aspect, the printing system of a seventeenth aspect, a printing management program of a twenty-sixth program, a printing-management-feature-provided printing device control program of a thirty-first aspect, the printing-management-feature-provided information processor control program of a thirty-sixth aspect, a printing management method of a forty-fourth aspect, a printing-management-feature-provided printing device control method of a forty-ninth aspect, and a printing-management-feature-provided information processor control method of a fifty-fifth aspect.

### Third Aspect

According to a printing management device of a third aspect, in the first or second aspect, the printing management device includes

an error information acquisition unit that acquires error information about an error occurred to any of the printing devices, and

based on the error information, the allocation details determination unit determines the allocation details to put any of the printing devices except the error-inflicted printing device in charge for the not-yet-completed part of the printing process.

With such a configuration, the error information acquisition unit acquires error information about any error occurred to the printing devices. Once such error information is acquired, the allocation details determination unit refers to the error information to determine allocation details for putting any of the printing devices except the error-inflicted printing device in charge for the not-yet-completed part of the printing process.

Accordingly, this effectively eliminates the risk of putting the error-inflicted printing device in charge for the printing process.

Herein, the expression of “putting any of the printing devices except the error-inflicted printing device in charge for the not-yet-completed part of the printing process” includes a case of determining allocation details in which an allocation ratio for the error-inflicted printing device is “0”. This is applicable in the following to a printing system of a tenth aspect, a printing management program of a nineteenth aspect, and a printing management method of a twenty-ninth aspect.

### Fourth Aspect

According to a printing management device of a fourth aspect, in any one of the first to third aspects, the printing management device includes

a capability information acquisition unit that acquires capability information about the performance capabilities of the printing devices, and

the allocation details determination unit determines the allocation details based on the capability information.

With such a configuration, the capability information acquisition unit acquires capability information about the performance capabilities of a plurality of printing devices. The allocation details determination unit determines the allocation details based on the acquired capability information.

This accordingly produces such effects as making rather-well-performing printing device(s) take charge of more processes than for rather-poorly-performing printing device(s). With this being the case, determining the allocation details based on the performance capabilities of the printing devices favorably increases efficiency.

### Fifth Aspect

According to a printing management device of a fifth aspect, in any one of the first to fourth aspects, the printing management device includes

a specification information acquisition unit that acquires specification information about the number of printing copies for any of the printing devices that takes charge of the printing process for the printing data, and

the allocation details determination unit determines the allocation details based on the specification information about the number of printing copies.

With such a configuration, the specification information acquisition unit acquires specification information about the number of printing copies for any of the printing devices that takes charge of the printing process for the printing data. The allocation details determination unit determines the allocation details based on such specification information about the number of printing copies.

Accordingly, when any specific printing data is to be printed for 100 copies, the user can make any other arbitrary printing devices print any arbitrary number of copies, e.g., three copies, as long as the number of copies is in the not-yet-completed range.

### Sixth Aspect

A sixth aspect of the invention is directed to a printing-management-feature-provided printing device that includes:

an allocation request information acquisition unit that acquires allocation request information for a printing process, including information for specifying printing data, and information about an allocation destination of the printing process;

a printing process status information acquisition unit that acquires, from a printing device being in the printing process for the printing data, printing process status information that indicates the printing process status of the printing data;

an allocation printing data acquisition unit that acquires printing data corresponding to the allocation request information;

an allocation details determination unit that determines, allocation details for the not-yet-completed part of the printing process based on the allocation request information and the printing process status information;

a printing data manipulation unit that manipulates the printing data derived by the allocation printing data acquisition unit based on the allocation details determined by the allocation details determination unit;

a manipulated printing data, transmission unit that transmits manipulated printing data as a result of manipulation of the printing data by the printing data manipulation unit to a printing device being an allocation destination of the manipulated printing data;

a printing data acquisition unit that acquires the printing data;

a printing data storage unit that stores the printing data acquired by the printing data acquisition unit; and

a printing process unit that executes the printing process based on the printing data stored in the printing data storage unit.

With such a configuration, the allocation request information acquisition unit acquires allocation request information about a printing process, including information for specifying printing data, and information about an allocation destination of the printing process. After the printing request information is acquired, the printing process status information acquisition unit acquires, from any of the printing devices that is currently executing the printing process for the printing data, printing process status information that indicates the printing process status of the printing data. The allocation printing data acquisition unit acquires printing data corresponding to the allocation request information. After the allocation request information and the printing process status information are acquired, based on such information, the allocation details determination unit determines allocation details for the not-yet-completed part of the printing process. Once the allocation details are determined as such, based thereon, the printing data manipulation unit manipulates the printing data acquired by the allocation printing data acquisition unit. After the printing data is manipulated, the manipulated printing data transmission unit transmits manipulated printing data as a result of manipulation of the printing data by the printing data manipulation unit to a printing device being an allocation destination of the manipulated printing data.

The printing data acquisition unit acquires printing data, and the acquired printing data is stored in the printing data storage unit. After the printing data is stored, the printing process unit starts executing a printing process based on the printing data in storage.

This leads to the printing device with the performance capabilities of the printing management device of the first aspect, thereby favorably easing the system configuration.

### Seventh Aspect

According to a printing-management-feature-provided printing device of a seventh aspect, in the sixth aspect,

the printing data is uniquely correlated with first personal identification information,

the allocation request information includes second personal identification information that is unique thereto, and correlated with the first personal identification information,

an allocation details determination process execution decision unit is provided for making a decision whether or not to subject the allocation details to a determination process based on the first and second personal identification information, and

when the allocation details determination process execution decision unit decides to subject the allocation details to the determination process, the allocation details determination unit executes the determination process.

With such a configuration, the allocation details determination process execution decision unit makes a decision whether or not to subject the allocation details to a determination process. Such a decision is made based on the first personal identification information that is correlated with the printing data, and the second personal identification information found in the allocation request information. When the determination process is determined as to be executed, the allocation details determination unit accordingly executes the determination process for the allocation details.

This leads to the printing device with the performance capabilities of the printing management device of the second aspect, thereby favorably easing the system configuration.

### Eighth Aspect

According to a printing-management-feature-provided printing device, in the sixth or seventh aspect, the printing-management-feature-provided printing device includes

an error information acquisition unit that acquires error information about an error occurred to the printing device, and

based on the error information, the allocation details determination unit determines the allocation details to put a printing device separately provided from the error-inflicted printing device in charge for the not-yet-completed part of the printing process.

With such a configuration, the error information acquisition unit acquires error information about any error occurred to the printing devices. Once such error information is acquired, the allocation details determination unit refers to the error information to determine allocation details for putting a printing device that is provided separately from the error-inflicted printing device in charge for the not-yet-completed part of the printing process.

This leads to the printing device with the performance capabilities of the printing management device of the third aspect, thereby favorably easing the system configuration.

### Ninth Aspect

According to a printing-management-feature-provided printing device of a ninth aspect, in any one of the sixth to eighth aspects, the printing-management-feature-provided printing device includes

a capability information acquisition unit that acquires capability information about the printing devices, and

the allocation details determination unit determines the allocation details based on the capability information.

With such a configuration, the capability information acquisition unit acquires capability information about the performance capabilities of a plurality of printing devices. The allocation details determination unit determines the allocation details based on the acquired capability information.

This leads to the printing device with the performance capabilities of the printing management device of the fourth aspect, thereby favorably easing the system configuration.

### Tenth Aspect

According to a printing-management-feature-provided printing device of a tenth aspect, in any one of the sixth to ninth aspects, the printing-management-feature-provided printing device includes

a specification information acquisition unit that acquires specification information about the number of printing copies for the printing device that takes charge of the printing process for the printing data, and

the allocation details determination unit determines the allocation details based on the specification information about the number of printing copies.

With such a configuration, the specification information acquisition unit acquires specification information about the number of printing copies for the printing device that takes charge of the printing process for the printing data. The allocation details determination unit determines the allocation details based on such specification information about the number of printing copies.

This leads to the printing device with the performance capabilities of the printing management device of the fifth aspect, thereby favorably easing the system configuration.

### Eleventh Aspect

An eleventh aspect of the invention is directed to a printing-management-feature-provided information processor that includes:

an allocation request information acquisition unit that acquires allocation request information for the printing process, including information for specifying printing data, and information about an allocation destination of the printing process;

a printing process status information acquisition unit that acquires, from the printing device being in the printing process for the printing data, printing process status information that indicates the printing process status of the printing data;

an allocation printing data acquisition unit that acquires printing data corresponding to the allocation request information;

an allocation details determination unit that determines allocation details for the not-yet-completed part of the printing process based on the allocation-request information and the printing process status information;

a printing data manipulation unit that manipulates the printing data derived by the allocation printing data acquisition unit based on the allocation details determined by the allocation details determination unit;

a manipulated printing data transmission unit that transmits manipulated printing data as a result of manipulation of the printing data by the printing data manipulation unit to a printing device being an allocation destination of the manipulated printing data;

a printing data acquisition unit that acquires the printing data;

a printing data storage unit that stores the printing data acquired by the printing data acquisition unit; and

a printing data transmission unit that transmits the printing data stored in the printing data storage unit to any of the printing devices that corresponds to the printing data.

With such a configuration, the allocation request information acquisition unit acquires allocation request information about a printing process, including information for specifying printing data, and information about an allocation destination of the printing process. After the printing request information is acquired, the printing process status information acquisition unit acquires, from any of the printing devices that is currently executing the printing process for the printing data, printing process status information that indicates the printing process status of the printing data. The allocation printing data acquisition unit acquires printing data corresponding to the allocation request information. After the allocation request information and the printing process status information are acquired, based on such information, the allocation details determination unit determines allocation details for the not-yet-completed part of the printing process. Once the allocation details are determined as such, based thereon, the printing data manipulation unit manipulates the printing data acquired by the allocation printing data acquisition unit. After the printing data is manipulated, the manipulated printing data transmission unit transmits manipulated printing data as a result of manipulation of the printing data by the printing data manipulation unit to any of the printing devices being an allocation destination of the manipulated printing data.

The printing data acquisition unit acquires the printing data, and the acquired printing data is stored in the printing data storage unit. After the printing data is stored, the stored printing data is forwarded to any of the corresponding printing devices.

This leads to the information processor with the performance capabilities of the printing management device of the first aspect, thereby providing the printing management capabilities to the printer server or others. Accordingly, this favorably eases system configuration, and simplifies the configuration of the system.

### Twelfth Aspect

According to a printing-management-feature-provided information processor of a twelfth aspect, in the eleventh aspect,

the printing data is uniquely correlated with first personal identification information,

the allocation request information includes second personal identification information that is unique thereto, and correlated with the first personal identification information,

an allocation details determination process execution decision unit is provided for making a decision whether or not to subject the allocation details to a determination process based on the first and second personal identification information, and

when the allocation details determination process execution decision unit decides to subject the allocation details to the determination process, the allocation details determination unit executes the determination process.

With such a configuration, the allocation details determination process execution decision unit makes a decision whether or not to subject the allocation details to a determination process. Such a decision is made based on the first personal identification information that is correlated with the printing data, and the second personal identification information found in the allocation request information. When the determination process is determined as to be executed, the allocation details determination unit accordingly executes the determination process for the allocation details.

This leads to the information processor with the performance capabilities of the printing management device of the second aspect, thereby providing the printing management capabilities to the printer server or others. Accordingly, this favorably eases system configuration, and simplifies the configuration of the system.

### Thirteenth Aspect

According to a printing-management-feature-provided information processor of a thirteenth aspect, in the eleventh or twelfth aspect, the printing-management-feature-provided information processor includes

an error information acquisition unit that acquires error information about an error occurred to any of the printing devices, and

based on the error information, the allocation details determination unit determines the allocation details to put any of the printing devices except the error-inflicted printing device in charge for the not-yet-completed part of the printing process.

With such a configuration, the error information acquisition unit acquires error information about any error occurred to the printing devices. Once such error information is acquired, the allocation details determination unit refers to the error information to determine allocation details for putting any of the printing devices except the error-inflicted printing device in charge for the not-yet-completed part of the printing process.

This leads to the information processor with the performance capabilities of the printing management device of the third aspect, thereby providing the printing management capabilities to the printer server or others. Accordingly, this favorably eases system configuration, and simplifies the configuration of the system.

### Fourteenth Aspect

According to a printing-management-feature-provided information processor of a fourteenth aspect, in any one of the eleventh to thirteenth aspects, the printing-management-feature-provided information processor includes

a capability information acquisition unit that acquires capability information about the printing devices, and

the allocation details determination unit determines the allocation details based on the capability information.

With such a configuration, the capability information acquisition unit acquires capability information about the performance capabilities of a plurality of printing devices. The allocation details determination unit determines the allocation details based on the acquired capability information.

This leads to the information processor with the performance capabilities of the printing management device of the fourth aspect, thereby providing the printing management capabilities to the printer server or others. Accordingly, this favorably eases system configuration, and simplifies the configuration of the system.

### Fifteenth Aspect

According to a printing-management-feature-provided information processor of a fifteenth aspect, in any one of the eleventh to fourteenth aspects, the printing-management-feature-provided information processor includes

a specification information acquisition unit that acquires specification information about the number of printing copies for any of the printing devices that takes charge of the printing process for the printing data, and

the allocation details determination unit determines the allocation details based on the specification information about the number of printing copies.

With such a configuration, the specification information acquisition unit acquires specification information about the number of printing copies for any of the printing devices that takes charge of the printing process for the printing data. The allocation details determination unit determines the allocation details based on such specification information about the number of printing copies.

This leads to the information processor with the performance capabilities of the printing management device of the fifth aspect, thereby providing the printing management capabilities to the printer server or others. Accordingly, this favorably eases system configuration, and simplifies the configuration of the system.

### Sixteenth Aspect

A sixteenth aspect of the invention is directed to a printing system that includes a plurality of printing devices each executing a printing process based on printing data. The printing system includes:

an allocation request information acquisition unit that acquires allocation request information for the printing process, including information for specifying the printing data, and information about an allocation destination of the printing process;

a printing process status information acquisition unit that acquires, from any of the printing devices being in the printing process for the printing data, printing process status information that indicates the printing process status of the printing data;

an allocation printing data acquisition unit that acquires printing data corresponding to the allocation request information;

an allocation details determination unit that determines allocation details for the not-yet-completed part of the printing process based on the allocation request information and the printing process status information;

a printing data manipulation unit that manipulates the printing data derived by the allocation printing data acquisition unit based on the allocation details determined by the allocation details determination unit; and

a manipulated printing data transmission unit that transmits manipulated printing data as a result of manipulation of the printing data by the printing data manipulation unit to any of the printing devices being an allocation destination of the manipulated printing data.

With such a configuration, the allocation request information acquisition unit acquires allocation request information about a printing process, including information for specifying printing data, and information about an allocation destination of the printing process. After the printing request information is acquired, the printing process status information acquisition unit acquires, from any of the printing devices that is currently executing the printing process for the printing data, printing process status information that indicates the printing process status of the printing data. The allocation printing data acquisition unit acquires printing data corresponding to the allocation request information. After the allocation request information and the printing process status information are acquired, based on such information, the allocation details determination unit determines allocation details for the not-yet-completed part of the printing process. Once the allocation details are determined as such, based thereon, the printing data manipulation unit manipulates the printing data acquired by the allocation printing data acquisition unit. After the printing data is manipulated, the manipulated printing data transmission unit transmits manipulated printing data as a result of manipulation of the printing data by the printing data manipulation unit to any of the printing devices being an allocation destination of the manipulated printing data.

As such, the printing process status information can be used as a basis to determine the allocation details for the not-yet-completed part of the printing process. This allows allocating and distributing any remaining printing process to any other arbitrary printing devices even if the printing process is in progress.

### Seventeenth Aspect

According to a printing system of a seventeenth aspect, in the sixteenth aspect,

the printing data is uniquely correlated with first personal identification information,

the allocation request information includes second personal identification information that is unique thereto, and correlated with the first personal identification information,

an allocation details determination process execution decision unit is provided for making a decision whether or not to subject the allocation details to a determination process based on the first and second personal identification information, and

when the allocation details determination process execution decision unit decides to subject the allocation details to the determination process, the allocation details determination unit executes the determination process.

With such a configuration, the allocation details determination process execution decision unit makes a decision whether or not to subject the allocation details to a determination process. Such a decision is made based on the first personal identification information that is correlated with the printing data, and the second personal identification information found in the allocation request information. When the determination process is determined as to be executed, the allocation details determination unit accordingly executes the determination process for the allocation details.

As such, the printing process is not allocated nor distributed until an allocation request is received together with appropriate personal identification information. This works well specifically when confidential documents are printed, and no third parties are allowed to issue an allocation request without the user's permission at his or her intended timing so that the confidential documents can be safely protected from stealing or peeking.

Note here that when the system is implemented as a network system with which a plurality of devices such as information processor and printing devices are connected together for communications thereamong, the units in the above may be provided to any of the devices.

### Eighteenth Aspect

According to a printing system of an eighteenth aspect, in the sixteenth or seventeenth aspect, the printing system includes

an error information acquisition unit that acquires error information about an error occurred to any of the printing devices, and

based on the error information, the allocation details determination unit determines allocation details to put any of the printing devices except the error-inflicted printing device in charge for the not-yet-completed part of the printing process.

With such a configuration, the error information acquisition unit acquires error information about any error occurred to the printing devices. Once such error information is acquired, the allocation details determination unit refers to the error information to determine allocation details for putting any of the printing devices except the error-inflicted printing device in charge for the not-yet-completed part of the printing process.

Accordingly, this effectively eliminates the risk of putting the error-inflicted printing device in charge for the printing process.

### Nineteenth Aspect

According to a printing system of a nineteenth aspect, in any one of the sixteenth to eighteenth aspects, the printing system includes

a capability information acquisition unit that acquires capability information about the performance capabilities of the printing devices, and

the allocation details determination unit determines the allocation details based on the capability information.

With such a configuration, the capability information acquisition unit acquires capability information about the performance capabilities of a plurality of printing devices. The allocation details determination unit determines the allocation details based on the acquired capability information.

This accordingly produces such effects as making rather-well-performing printing device(s) take charge of more processes than for rather-poorly-performing printing device(s). With this being the case, determining the allocation details based on the performance capabilities of the printing devices favorably increases efficiency.

### Twentieth Aspect

According to a printing system of a twentieth aspect, in any one of the sixteenth to nineteenth aspects, the printing system includes

a specification information acquisition unit that acquires specification information about the number of printing copies for any of the printing devices that takes charge of the printing process for the printing data, and

the allocation details determination unit determines the allocation details based on the specification information about the number of printing copies.

With such a configuration, the specification information acquisition unit acquires specification information about the number of printing copies for any of the printing devices that takes charge of the printing process for the printing data. The allocation details determination unit determines the allocation details based on such specification information about the number of printing copies.

Accordingly, when any specific printing data is to be printed for 100 copies, the user can make any other arbitrary printing devices print any arbitrary number of copies, e.g., three copies, as long as the number of copies is in the not-yet-completed range.

### Twenty-first Aspect

A twenty-first aspect of the invention is directed to a printing system, including:

the printing management device of any one of the first to fifth aspects; and

two or more of the printing device, wherein

the printing management device is connected to the printing devices for data communications,

the printing management device

includes an acquisition request transmission unit that transmits an acquisition request to any of the printing devices for the printing process status information, and

the printing devices each include:

a printing data acquisition unit that acquires printing data;

a printing data storage unit that stores the printing data acquired by the printing data acquisition unit;

a printing process unit that executes a printing process based on the printing data stored in the printing data storage unit;

an allocation request information input unit that inputs the allocation request information;

an allocation request information transmission unit that transmits, to the printing management device, the allocation request information input by the allocation request information input unit; and

a printing process status information transmission unit that transmits the printing process status information to the printing management device based on the acquisition request coming from the printing management device for the printing process status information.

With such a configuration, the printing management device can transmit, by the acquisition request transmission unit, an acquisition request to any of the printing devices for the printing process status information.

The printing devices can each acquire printing data by the printing data acquisition unit, store the printing data acquired by the printing data acquisition unit by the printing data storage unit, execute a printing process by the printing process unit based on the printing data stored in the printing data storage unit, input allocation request information by the allocation request information input unit, transmit the allocation request information input by the allocation request information input unit to the printing management device by the allocation request information transmission unit, and transmit the printing process status information to the printing management device by the printing process status information transmission unit based on the acquisition request coming from the printing management device for the printing process status information.

As such, the printing process status information can be used as a basis to determine the allocation details for the not-yet-completed part of the printing process. This allows allocating and distributing any remaining printing process to any other arbitrary printing devices even if the printing process is in progress.

### Twenty-Second Aspect

A twenty-second aspect of the invention is directed to a printing system, including:

the printing-management-feature-provided printing device of the sixth aspect, and

one or more of the printing device, wherein

the printing-management-feature-provided printing device is connected to the printing device for data communications,

the printing-management-feature-provided printing device

includes an acquisition request transmission unit that transmits an acquisition request to the printing device for printing process status information, and

the printing device includes:

a printing data acquisition unit that acquires printing data;

a printing data storage unit that stores the printing data acquired by the printing data acquisition unit;

a printing process unit that executes a printing process based on the printing data stored in the printing data storage unit;

an allocation request information input unit that inputs the allocation request information;

an allocation request information transmission unit that transmits, to the printing-management-feature-provided printing device, the allocation request information input by the allocation request information input unit; and

a printing process status information transmission unit that transmits the printing process status information to the printing-management-feature-provided printing device based on the acquisition request coming from the printing-management-feature-provided printing device for the printing process status information.

With such a configuration, the printing-management-feature-provided printing device can transmit, by the acquisition request transmission unit, an acquisition request to the printing device for the printing process status information.

The printing device can acquire printing data by the printing data acquisition unit, store the printing data acquired by the printing data acquisition unit by the printing data storage unit, execute a printing process by the printing process unit based on the printing data stored in the printing data storage unit, input allocation request information by the allocation request information input unit, transmit the allocation request information input by the allocation request information input unit to the printing management device by the allocation request information transmission unit, and transmit the printing process status information to the printing management device by the printing process status information transmission unit based on the acquisition request coming from the printing management device for the printing process status information.

As such, the printing process status information can be used as a basis to determine the allocation details for the not-yet-completed part of the printing process. This allows allocating and distributing any remaining printing process to any other arbitrary printing devices even if the printing process is in progress.

### Twenty-Third Aspect

A twenty-third aspect of the invention is directed to a printing system, including:

the printing-management-feature-provided information processor of any one of the eleventh to fifteenth aspects; and

two or more of the printing device, wherein

the printing-management-feature-provided information processor includes

an acquisition request transmission unit that transmits an acquisition request to any of the printing devices for printing process status information, and

the printing devices each include:

a printing data acquisition unit that acquires printing data;

a printing data storage unit that stores the printing data acquired by the printing data acquisition unit;

a printing process unit that executes a printing process based on the printing data stored in the printing data storage unit;

an allocation request information input unit that inputs the allocation request information;

an allocation request information transmission unit that transmits, to the printing-management-feature-provided information processor, the allocation request information input by the allocation request information input unit; and

a printing process status information transmission unit that transmits the printing process status information to the printing-management-feature-provided information processor based on the acquisition request coming from the printing-management-feature-provided information processor for the printing process status information.

With such a configuration, the printing-management-feature-provided information processor can transmit, by the acquisition request transmission unit, an acquisition request to any of the printing devices for the printing process status information.

The printing devices can each acquire printing data by the printing data acquisition unit, store the printing data acquired by the printing data acquisition unit by the printing data storage unit, execute a printing process by the printing process unit based on the printing data stored in the printing data storage unit, input allocation request information by the allocation request information input unit by the allocation request information input unit, transmit the allocation request information input by the allocation request information input unit to the printing management device by the allocation request information transmission unit, and transmit the printing process status information to the printing management device by the printing process status information transmission unit based on the acquisition request coming from the printing management device for the printing process status information.

As such, the printing process status information can be used as a basis to determine the allocation details for the not-yet-completed part of the printing process. This allows allocating and distributing any remaining printing process to any other arbitrary printing devices even if the printing process is in progress.

### Twenty-fourth Aspect

A twenty-fourth aspect of the invention is directed to a printing device, including:

a printing data acquisition unit that acquires printing data;

a printing data storage unit that stores the printing data acquired by the printing data acquisition unit;

a printing process unit that executes a printing process based on the printing data stored in the printing data storage unit;

an allocation request information input unit that inputs allocation request information about the printing process, including information for specifying the printing data, and information about an allocation destination of the printing process for the printing data;

an allocation request information transmission unit that transmits, to the printing management device, the allocation request information input by the allocation request information input unit; and

a printing process status information transmission unit that transmits the printing process status information to the printing management device based on an acquisition request coming from the printing management device for printing process status information that indicates the printing process status of the printing data.

With such a configuration, the printing data acquisition unit can acquire printing data, the printing data storage unit can store the printing data acquired by the printing data acquisition unit, the printing process unit can execute a printing process based on the printing data stored in the printing data storage unit, the allocation request information input unit can input allocation request information, the allocation request information transmission unit can transmit the allocation request information input by the allocation request information input unit, and the printing process status information transmission unit can transmit the printing process status information to the printing management device based on an acquisition request coming from the printing management device for the printing process status information.

The printing device of this aspect is applicable to the printing system of any one of the twenty-first to twenty-third aspects, and can achieve similar effects and advantages as the printing system of any one of the twenty-first to twenty-third aspects.

### Twenty-Fifth Aspect

A twenty-fifth aspect of the invention is directed to a printing management program that determines allocation details for a printing process in a system including a plurality of printing devices that execute the printing process based on printing data, the program includes the steps of, for use with a computer:

acquiring allocation request information for the printing process that includes information for specifying the printing data, and information about an allocation destination of the printing process;

acquiring, from any of the printing devices being in the printing process for the printing data, printing process status information that indicates the printing process status of the printing data;

acquiring printing data corresponding to the allocation request information;

determining allocation details for the not-yet-completed part of the printing process based on the allocation request information and the printing process status information;

manipulating the printing data derived in the allocation printing data acquisition step based on the allocation details determined in the allocation details determination step; and

transmitting manipulated printing data as a result of manipulation of the printing data in the printing data manipulation step to any of the printing devices being an allocation destination of the manipulated printing data.

With such a configuration, a computer reads a program, and when the computer starts executing processes in accordance with the program, the effects and advantages similar to the printing management device of the first aspect can be derived.

### Twenty-Sixth Aspect

According to a printing management program of a twenty-sixth aspect, in the twenty-fifth aspect,

the printing data is uniquely correlated with first personal identification information,

the allocation request information includes second personal identification information that is unique thereto, and correlated with the first personal identification information,

a program is further provided, for use with a computer, in which an allocation details determination process execution decision step decides whether or not to subject the allocation details of the printing process to a determination process based on the first and second personal identification information, and

when the allocation details determination process execution decision step decides to subject the allocation details to the determination process, the allocation details determination step executes the determination process.

With such a configuration, a computer reads a program, and when the computer starts executing processes in accordance with the program, the effects and advantages similar to the printing management device of the second aspect can be derived.

### Twenty-Seventh Aspect

According to a printing management program of a twenty-seventh aspect, in the twenty-fifth or twenty-sixth aspect, the printing management program further includes

a program, for use with a computer, in which an error information acquisition step acquires error information about an error occurred to any of the printing devices, and

based on the error information, the allocation details determination step determines the allocation details to put any of the printing devices except the error-inflicted printing device in charge for the printing process.

With such a configuration, a computer reads a program, and when the computer starts executing processes in accordance with the program, the effects and advantages similar to the printing management device of the third aspect can be derived.

### Twenty-Eighth Aspect

According to a printing management program of a twenty-eighth aspect, in any one of the twenty-fifth to twenty-seventh aspects, the printing management program further includes

a program, for use with a computer, in which a capability information acquisition step acquires capability information about the performance capabilities of the printing devices, and

the allocation details determination step determines the allocation details based on the capability information.

With such a configuration, a computer reads a program, and when the computer starts executing processes in accordance with the program, the effects and advantages similar to the printing management device of the fourth aspect can be derived.

### Twenty-Ninth Aspect

According to a printing management program of a twenty-ninth aspect, in any one of the twenty-fifth to twenty-eighth aspects, the printing management program further includes

a program, for use with a computer, in which a specification information acquisition step acquires specification information about the number of printing copies for any of the printing devices that takes charge of the printing process for the printing data, and

the allocation details determination unit determines the allocation details based on the specification information about the number of printing copies.

With such a configuration, a computer reads a program, and when the computer starts executing processes in accordance with the program, the effects and advantages similar to the printing management device of the fifth aspect can be derived.

### Thirtieth Aspect

A thirtieth aspect of the invention is directed to a printing-management-feature-provided printing device control program. The printing-management-feature-provided printing device control program is used to control a printing-management-feature-provided printing device that determines allocation details for a printing process in a system including a plurality of printing devices that execute the printing process based on printing data. The program includes the steps of, for use with a computer:

acquiring allocation request information for the printing process that includes information for specifying the printing data, and information about an allocation destination of the printing process;

acquiring, from any of the printing devices being in the printing process for the printing data, printing process status information that indicates the printing process status of the printing data;

acquiring printing data corresponding to the allocation request information;

determining allocation details for the not-yet-completed part of the printing process based on the allocation request information and the printing process status information;

manipulating the printing data derived in the allocation printing data acquisition step based on the allocation details determined in the allocation details determination step; and

transmitting manipulated printing data as a result of manipulation of the printing data in the printing data manipulation step to any of the printing devices being an allocation destination of the manipulated printing data;

acquiring the printing data;

storing the printing data acquired in the printing data acquisition step into a printing data storage unit; and

executing the printing process based on the printing data stored in the printing data storage unit.

With such a configuration, a computer reads a program, and when the computer starts executing processes in accordance with the program, the effects and advantages similar to the printing-management-feature-provided printing device of the sixth aspect can be derived.

### Thirty-First Aspect

According to a printing-management-feature-provided printing device control program of a thirty-first aspect, in the thirtieth aspect,

the printing data is uniquely correlated with first personal identification information,

the allocation request information includes second personal identification information that is unique thereto, and correlated with the first personal identification information,

a program is further provided, for use with a computer, in which an allocation details determination process execution decision step decides whether or not to subject the allocation details of the printing process to a determination process based on the first and second personal identification information, and

when the allocation details determination process execution decision step decides to subject the allocation details to the determination process, the allocation details determination step executes the determination process.

With such a configuration, a computer reads a program, and when the computer starts executing processes in accordance with the program, the effects and advantages similar to the printing-management-feature-provided printing device of the seventh aspect can be derived.

### Thirty-Second Aspect

According to a printing-management-feature-provided printing device control program of a thirty-second aspect, in the thirtieth or thirty-first aspect, the printing-management-feature-provided printing device control program further includes

a program, for use with a computer, in which an error information acquisition step acquires error information about an error occurred to any of the printing devices, and

based on the error information, the allocation details determination unit determines the allocation details to put any of the printing devices except the error-inflicted printing device in charge for the printing process.

With such a configuration, a computer reads a program, and when the computer starts executing processes in accordance with the program, the effects and advantages similar to the printing-management-feature-provided printing device of the eighth aspect can be derived.

### Thirty-Third Aspect

According to a printing-management-feature-provided printing device control program of a thirty-third aspect, in any one of the thirtieth to thirty-second aspects, the printing-management-feature-provided printing device control program further includes

a program, for use with a computer, in which a capability information acquisition step acquires capability information about the performance capabilities of the printing devices, and

the allocation details determination unit determines the allocation details based on the capability information.

With such a configuration, a computer reads a program, and when the computer starts executing processes in accordance with the program, the effects and advantages similar to the printing-management-feature-provided printing device of the ninth aspect can be derived.

Thirty-Fourth Aspect

According to a printing-management-feature-provided printing device control program of a thirty-fourth aspect, in any one of the thirtieth to thirty-third aspects, the printing-management-feature-provided printing device control program includes

a program, for use with a computer, in which a specification information acquisition step acquires specification information about the number of printing copies for any of the printing devices that takes charge of the printing process for the printing data, and

the allocation details determination step determines the allocation details based on the specification information about the number of printing copies.

With such a configuration, a computer reads a program, and when the computer starts executing processes in accordance with the program, the effects and advantages similar to the printing-management-feature-provided printing device of the tenth aspect can be derived.

### Thirty-Fifth Aspect

According to a printing-management-feature-provided printing device control program of a thirty-fifth aspect, in any one of the thirtieth to thirty-fourth aspects, the printing-management-feature-provided printing device control program further includes

a program for use with a computer to execute an acquisition request transmission step of transmitting an acquisition request about the printing process status to any of the printing devices.

With such a configuration, a computer reads a program, and when the computer starts executing processes in accordance with the program, the effects and advantages similar to the printing system of the twenty-second aspect can be derived.

### Thirty-Sixth Aspect

A thirty-sixth aspect of the invention is directed to a printing-management-feature-provided information processor control program. The printing-management-feature-provided information processor control program is used to control a printing-management-feature-provided printing device that determines allocation details for a printing process in a system including a plurality of printing devices that execute the printing process based on printing data. The program includes the steps of, for use with a computer:

acquiring allocation request information for the printing process that includes information for specifying the printing data, and information about an allocation destination of the printing process;

acquiring, from any of the printing devices being in the printing process for the printing data, printing process status information that indicates the printing process status of the printing data;

acquiring printing data corresponding to the allocation request information;

determining allocation details for the not-yet-completed part of the printing process based on the allocation request information and the printing process status information;

manipulating the printing data derived in the allocation printing data acquisition step based on the allocation details determined in the allocation details determination step; and

transmitting manipulated printing data as a result of manipulation of the printing data in the printing data manipulation step to any of the printing devices being an allocation destination of the manipulated printing data;

acquiring the printing data;

storing the printing data acquired in the printing data acquisition step into a printing data storage unit; and

transmitting the printing data stored in the printing data storage unit to any of the printing devices corresponding to the printing data.

With such a configuration, a computer reads a program, and when the computer starts executing processes in accordance with the program, the effects and advantages similar to the printing-management-feature-provided information processor of the eleventh aspect can be derived.

### Thirty-Seventh Aspect

According to a printing-management-feature-provided information processor control program of a thirty-seventh aspect, in the thirty-sixth aspect,

the printing data is uniquely correlated with first personal identification information,

the allocation request information includes second personal identification information that is unique thereto, and correlated with the first personal identification information,

a program is further provided, for use with a computer, in which an allocation details determination process execution decision step decides whether or not to subject the allocation details of the printing process to a determination process based on the first and second personal identification information, and

when the allocation details determination process execution decision step decides to subject the allocation details to the determination process, the allocation details determination step executes the determination process.

With such a configuration, a computer reads a program, and when the computer starts executing processes in accordance with the program, the effects and advantages similar to the printing-management-feature-provided information processor of the twelfth aspect can be derived.

### Thirty-Eighth Aspect

According to a printing-management-feature-provided information processor control program of a thirty-eighth aspect, in the thirty-sixth or thirty-seventh aspect, the printing-management-feature-provided information processor control program further includes

a program, for use with a computer, in which an error information acquisition step acquires error information about an error occurred to any of the printing devices, and

based on the error information, the allocation details determination step determines allocation details to put any of the printing devices except the error-inflicted printing device in charge for the printing process.

With such a configuration, a computer reads a program, and when the computer starts executing processes in accordance with the program, the effects and advantages similar to the printing-management-feature-provided information processor of the thirteenth aspect can be derived.

### Thirty-Ninth Aspect

According to a printing-management-feature-provided information processor control program of a thirty-ninth aspect, in any one of the thirty-sixth to thirty-eighth aspects, the printing-management-feature-provided information processor control program further includes

a program, for use with a computer, in which a capability information acquisition step acquires capability information about the performance capabilities of the printing devices, and

the allocation details determination step determines the allocation details based on the capability information.

With such a configuration, a computer reads a program, and when the computer starts executing processes in accordance with the program, the effects and advantages similar to the printing-management-feature-provided information processor of the fourteenth aspect can be derived.

### Fortieth Aspect

According to a printing-management-feature-provided information processor control program of a fortieth aspect, in any one of the thirty-sixth to thirty-ninth aspects, the printing-management-feature-provided information processor control program further includes

a program, for use with a computer, in which a specification information acquisition step acquires specification information about the number of printing copies for any of the printing devices that takes charge of the printing process for the printing data, and

the allocation details determination step determines the allocation details based on the specification information about the number of printing copies.

With such a configuration, a computer reads a program, and when the computer starts executing processes in accordance with the program, the effects and advantages similar to the printing-management-feature-provided information processor of the fifteenth aspect can be derived.

### Forty-First Aspect

According to a printing-management-feature-provided information processor control program of a forty-first aspect, in any one of the thirty-sixth to thirty-ninth aspects, the printing-management-feature-provided information processor control program further includes

a program for use with a computer to execute an acquisition request transmission step of transmitting an acquisition request about the printing process status to any of the printing devices.

With such a configuration, a computer reads a program, and when the computer starts executing processes in accordance with the program, the effects and advantages similar to the printing-management-feature-provided information processor of the twenty-third aspect can be derived.

### Forty-Second aspect

A forty-second aspect of the invention is directed to a printing device control program, including the steps of, for use with a computer:

acquiring printing data;

storing the printing data acquired in the printing data acquisition step;

executing a printing process based on the printing data stored in the printing data storage unit;

inputting allocation request information about the printing process that includes information for specifying the printing data, and information about an allocation destination of the printing process for the printing data;

transmitting, to the printing management device, the allocation request information input in the allocation request information input step; and

transmitting the printing process status information to the printing management device based on an acquisition request coming from the printing management device for printing process status information that indicates the printing process status of the printing data.

With such a configuration, a computer reads a program, and when the computer starts executing processes in accordance with the program, the effects and advantages similar to the printing device of the sixteenth aspect can be derived.

### Forty-Third Aspect

A forty-third aspect of the invention is directed to a printing management method that determines allocation details for a printing process in a system including a plurality of printing devices that execute the printing process based on printing data. The printing method includes the steps of:

acquiring allocation request information for the printing process that includes information for specifying the printing data, and information about an allocation destination of the printing process;

acquiring, from any of the printing devices being in the printing process for the printing data, printing process status information that indicates the printing process status of the printing data;

acquiring printing data corresponding to the allocation request information;

determining allocation details for the not-yet-completed part of the printing process based on the allocation request information and the printing process status information;

manipulating the printing data derived in the allocation printing data acquisition step based on the allocation details determined in the allocation details determination step; and

transmitting manipulated printing data as a result of manipulation of the printing data in the printing data manipulation step to any of the printing devices being an allocation destination of the manipulated printing data.

With such a method, the effects and advantages similar to those achieved by the printing management device of the first aspect can be derived.

### Forty-Fourth Aspect

According to a printing management method of a forty-fourth aspect, in the forty-third aspect,

the printing data is uniquely correlated with first personal identification information,

the allocation request information includes second personal identification information that is unique thereto, and correlated with the first personal identification information,

an allocation details determination process execution decision step is further provided to making a decision whether or not to subject the allocation details of the printing process to a determination process based on the first and second personal identification information, and

when the allocation details determination process execution decision step decides to subject the allocation details to the determination process, the allocation details determination step executes the determination process.

With such a method, the effects and advantages similar to those achieved by the printing management device of the second aspect can be derived.

### Forty-Fifth Aspect

According to a printing management method of a forty-fifth aspect, in the forty-third or forty-fourth aspect, the printing management method further includes

an error information acquisition step of acquiring error information about an error occurred to any of the printing devices, and

based on the error information, the allocation details determination step determines the allocation details to put any of the printing devices except the error-inflicted printing device in charge for the printing process.

With such a method, the effects and advantages similar to those achieved by the printing management device of the third aspect can be derived.

### Forty-Sixth Aspect

According to a printing management method of a forty-sixth aspect, in any one of the forty-third to forty-fifth aspects, the printing management method further includes

a capability information acquisition step of acquiring capability information about the performance capabilities of the printing devices, and

the allocation details determination step determines the allocation details based on the capability information.

With such a method, the effects and advantages similar to those achieved by the printing management device of the fourth aspect can be derived.

### Forty-Seventh Aspect

According to a printing management method of a forty-seventh aspect, in any one of the forty-third to forty-sixth aspects, the printing management method further includes

a specification information acquisition step of acquiring specification information about the number of printing copies for any of the printing devices that takes charge of the printing process for the printing data, and

the allocation details determination step determines the allocation details based on the specification information about the number of printing copies.

With such a method, the effects and advantages similar to those achieved by the printing management device of the fifth aspect can be derived.

### Forty-Eighth Aspect

A forty-eighth aspect of the invention is directed to a printing-management-feature-provided printing device control method. The printing-management-feature-provided printing device control method is used to control a printing-management-feature-provided printing device that determines allocation details for a printing process in a system including a plurality of printing devices that execute the printing process based on printing data. The method includes the steps of:

acquiring allocation request information for the printing process that includes information for specifying the printing data, and information about an allocation destination of the printing process;

acquiring, from any of the printing devices being in the printing process for the printing data, printing process status information that indicates the printing process status of the printing data;

acquiring printing data corresponding to the allocation request information;

determining allocation details for the not-yet-completed part of the printing process based on the allocation request information and the printing process status information;

manipulating the printing data derived in the allocation printing data acquisition step based on the allocation details determined in the allocation details determination step;

transmitting manipulated printing data as a result of manipulation of the printing data in the printing data manipulation step to any of the printing devices being an allocation destination of the manipulated printing data;

acquiring the printing data; and

executing the printing process based on the printing data acquired in the printing data acquisition step.

With such a method, the effects and advantages similar to those achieved by the printing-management-feature-provided printing device of the sixth aspect can be derived.

### Forty-Ninth Aspect

According to a printing-management-feature-provided printing device control method of a forty-ninth aspect, in the forty-eighth aspect,

the printing data is uniquely correlated with first personal identification information,

the allocation request information includes second personal identification information that is unique thereto, and correlated with the first personal identification information,

an allocation details determination process execution decision step is further provided for making a decision whether or not to subject the allocation details of the printing process to a determination process based on the first and second personal identification information, and

when the allocation details determination process execution decision step decides to subject the allocation details to the determination process, the allocation details determination step executes the determination process.

With such a method, the effects and advantages similar to those achieved by the printing-management-feature-provided printing device of the seventh aspect can be derived.

### Fiftieth Aspect

According to a printing-management-feature-provided printing device control method of a fiftieth aspect, in the forty-eighth or forty-ninth aspect, the printing-management-feature-provided printing device control method further includes

an error information acquisition step of acquiring error information about an error occurred to any of the printing devices, and

based on the error information, the allocation details determination step determines the allocation details to put any of the printing devices except the error-inflicted printing device in charge for the printing process.

With such a method, the effects and advantages similar to those achieved by the printing-management-feature-provided printing device of the eighth aspect can be derived.

### Fifty-First Aspect

According to a printing-management-feature-provided printing device control method of a fifty-first aspect, in any one of the forty-eighth to fiftieth aspects, the printing-management-feature-provided printing device control method further includes

a capability information acquisition step of acquiring capability information about the performance capabilities of the printing devices, and

the allocation details determination step determines the allocation details based on the capability information.

With such a method, the effects and advantages similar to those achieved by the printing-management-feature-provided printing device of the ninth aspect can be derived.

### Fifty-Second Aspect

According to a printing-management-feature-provided printing device control method of a fifty-second aspect, in any one of forty-eighth to fifty-first aspects, the printing-management-feature-provided printing device control method further includes

a specification information acquisition step of acquiring specification information about the number of printing copies for any of the printing devices that takes charge of the printing process for the printing data, and

the allocation details determination step determines the allocation details based on the specification information about the number of printing copies.

With such a method, the effects and advantages similar to those achieved by the printing-management-feature-provided printing device of the tenth aspect can be derived.

### Fifty-Third Aspect

According to a printing-management-feature-provided printing device control method of a fifty-third aspect, in any one of the forty-eighth to fifty-second aspects, the printing-management-feature-provided printing device control method further includes

an acquisition request transmission step of transmitting an acquisition request about the printing process status to any of the printing devices.

With such a method, the effects and advantages similar to those achieved by the printing-management-feature-provided printing device in the printing system of the twenty-second aspect can be derived.

### Fifty-Fourth Aspect

A fifty-fourth aspect of the invention is directed to a printing-management-feature-provided information processor control method. The printing-management-feature-provided information processor control method is used to control a printing-management-feature-provided information processor that determines allocation details for a printing process in a system including a plurality of printing devices that execute the printing process based on printing data. The method includes the steps of:

acquiring allocation request information for the printing process that includes information for specifying the printing data, and information about an allocation destination of the printing process;

acquiring, from any of the printing devices being in the printing process for the printing data, printing process status information that indicates the printing process status of the printing data;

acquiring printing data corresponding to the allocation request information;

determining allocation details for the not-yet-completed part of the printing process based on the allocation request information and the printing process status information;

manipulating the printing data derived in the allocation printing data acquisition step based on the allocation details determined in the allocation details determination step; and

transmitting manipulated printing data as a result of manipulation of the printing data in the printing data manipulation step to any of the printing devices being an allocation destination of the manipulated printing data;

acquiring the printing data;

storing the printing data acquired in the printing data acquisition step into a printing data storage unit; and

transmitting the printing data stored in the printing data storage unit to any of the printing devices corresponding to the printing data.

With such a method, the effects and advantages similar to those achieved by the printing-management-feature-provided information processor of the eleventh aspect can be derived.

### Fifty-Fifth Aspect

According to a printing-management-feature-provided information processor control method of a fifty-fifth aspect, in the fifty-fourth aspect,

the printing data is uniquely correlated with first personal identification information,

the allocation request information includes second personal identification information that is unique thereto, and correlated with the first personal identification information,

an allocation details determination process execution decision step is further provided to make a decision whether or not to subject the allocation details of the printing process to a determination process based on the first and second personal identification information, and

when the allocation details determination process execution decision step decides to subject the allocation details to the determination process, the allocation details determination step executes the determination process.

With such a method, the effects and advantages similar to those achieved by the printing-management-feature-provided information processor of the twelfth aspect can be derived.

### Fifty-Sixth Aspect

According to a printing-management-feature-provided information processor control method of a fifty-sixth aspect, in the fifty-fourth or fifty-fifth aspect, the printing-management-feature-provided information processor control method further includes

an error information acquisition step of acquiring error information about an error occurred to any of the printing devices, and

based on the error information, the allocation details determination step determines the allocation details to put any of the printing devices except the error-inflicted printing device in charge for the printing process.

With such a method, the effects and advantages similar to those achieved by the printing-management-feature-provided information processor of the thirteenth aspect can be derived.

### Fifty-Seventh Aspect

According to a printing-management-feature-provided information processor control method of a fifty-seventh aspect, in any one of the fifty-fourth to fifty-sixth aspect, the printing-management-feature-provided information processor control method further includes

a capability information acquisition step of acquiring capability information about the performance capabilities of the printing devices, and

the allocation details determination step determines the allocation details based on the capability information.

With such a method, the effects and advantages similar to those achieved by the printing-management-feature-provided information processor of the fourteenth aspect can be derived.

### Fifty-Eighth Aspect

According to a printing-management-feature-provided information processor control method of a fifty-eighth aspect, in any one of the fifty-fourth to fifty-seventh aspects, the printing-management-feature-provided information processor control method further includes

a specification information acquisition step of acquiring specification information about the number of printing copies for any of the printing devices that takes charge of the printing process for the printing data, and

the allocation details determination step determines the allocation details based on the specification information about the number of printing copies.

With such a method, the effects and advantages similar to those achieved by the printing-management-feature-provided information processor of the fifteenth aspect can be derived.

### Fifty-Ninth Aspect

According to a printing-management-feature-provided information processor control method of a fifty-ninth aspect, in any one of the fifty-fourth to fifty-eighth aspects, the printing-management-feature-provided information processor control method further includes

an acquisition request transmission step of transmitting an acquisition request about the printing process status to any of the printing devices.

With such a method, the effects and advantages similar to those achieved by the printing-management-feature-provided information processor in the printing system of the twenty-third aspect can be derived.

### Sixtieth Aspect

A sixtieth aspect of the invention is directed to a printing device control method, including the steps of:

acquiring printing data;

storing the printing data acquired in the printing data acquisition step;

executing a printing process based on the printing data stored in the printing data storage unit;

inputting allocation request information about the printing process that includes information for specifying the printing data, and information about an allocation destination of the printing process for the printing data;

transmitting, to the printing management device, the allocation request information input in the allocation request information input step; and

transmitting the printing process status information to the printing management device based on an acquisition request coming from the printing management device for printing process status information that indicates the printing process status of the printing data.

With such a method, the effects and advantages similar to those achieved by the printing device of the twenty-fourth aspect can be derived.

### BRIEF DESCRIPTION OF THE DRAWINGS

The invention will be described with reference to the accompanying drawings, wherein like numbers reference like elements.

FIG. 1 is an overview diagram showing the configuration of a printing system 1 of the invention;

FIG. 2 is a block diagram showing the detailed configuration of a printing command device 2;

FIG. 3 is a block diagram showing the detailed configuration of a printer server 3;

FIG. 4 is a block diagram showing the detailed configuration of a printing device 4;

FIG. 5 is a flowchart of a printing command process in the printing command device 2;

FIG. 6 is a flowchart of a printing allocation process in a printer server;

FIG. 7 is a flowchart of a printing process in the printing device 4;

FIGS. 8A to 8C are all diagrams showing exemplary capability information coming from printing devices 4A to 4C;

FIG. 9A is a diagram showing exemplary allocation request information coming from the printing device 4;

FIG. 9B is a diagram showing exemplary printing process status information coming from the printing device 4;

FIG. 9C is a diagram showing exemplary error information coming from the printing device 4;

FIGS. 9D and 9E are both diagrams showing exemplary printing process status information at the time of error occurrence;

FIG. 10A is a diagram showing exemplary allocation details to be determined by an allocation details determination section 3d;

FIG. 10B is a diagram showing exemplary allocation details that is determined again due to error occurrence;

FIG. 11A is a diagram showing exemplary header information of the printing data before the allocation details are determined;

FIGS. 11B and 11C are both diagrams showing exemplary header information of the printing data manipulated based on the allocation details;

FIG. 11D is a diagram showing exemplary header information of the printing data manipulated based on the allocation details determined again due to error occurrence;

FIG. 12 is an overview diagram showing the configuration of a printing system 6 of the invention;

FIG. 13 is a block diagram showing the detailed configuration of a management-feature-provided printing device 7;

FIG. 14 is a block diagram showing the detailed configuration of a printing device 4′;

FIG. 15 is a flowchart of a printing allocation process in the management-feature-provided printing device 7;

FIG. 16 is a flowchart of a printing process in the printing device 4′;

FIG. 17A is a diagram showing exemplary information to be extracted by an analysis process executed to the printing data;

FIG. 17B is a diagram showing exemplary capability information of the management-feature-provided printing device 7;

FIG. 17C is a diagram showing exemplary capability information of the printing device 4C′;

FIG. 17D is a diagram showing exemplary first allocation request information;

FIG. 17E is a diagram showing exemplary allocation number of printing copies to be input through an input panel;

FIG. 17F is a diagram showing exemplary second allocation request information when a setting is made to the allocation number of printing copies;

FIG. 17G is a diagram showing exemplary second allocation request information when no setting is made to the allocation number of printing copies;

FIGS. 18A to 18C are all diagrams showing exemplary allocation details to be determined by an allocation details determination section 7f;

FIG. 19A is a diagram showing exemplary header information of the printing data before the allocation details are determined; and

FIGS. 19B and 19C are both diagrams showing exemplary header information of the printing data manipulated based on the allocation details.

### DESCRIPTION OF EXEMPLARY EMBODIMENTS

### First Embodiment

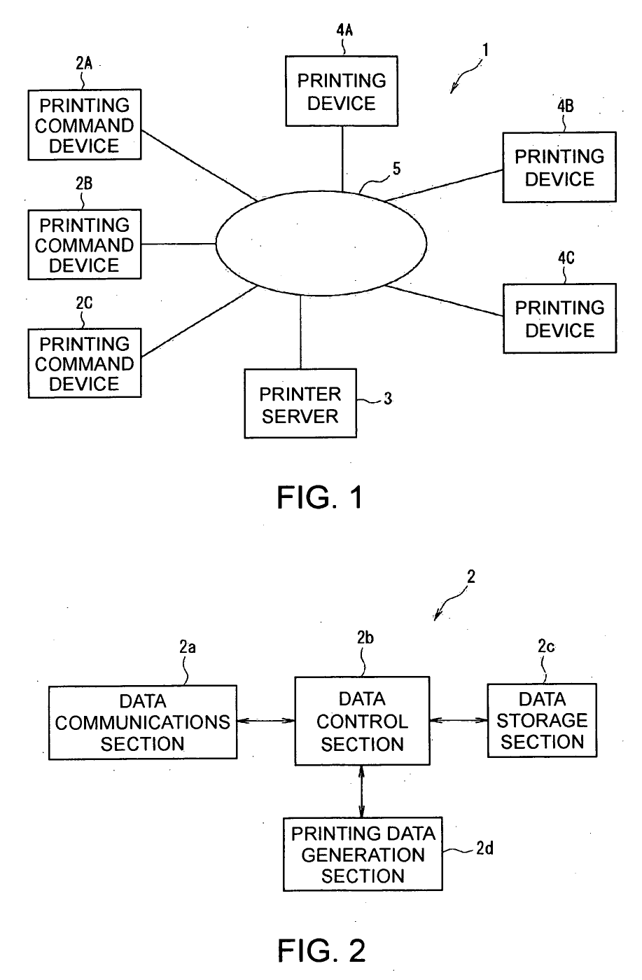

In the following, a first embodiment of the invention will be described by referring to the accompanying drawings. FIGS. 1 to 11D are all diagrams showing the first embodiment of the invention, i.e., a printing management device, a printing-management-feature-provided information processor, a printing system, a printing device, a printing management program, a printing-management-feature-provided information processor control program, a printing device control program, a printing management method, a printing-management-feature-provided information processor control method, and a printing device control method.

By referring to FIG. 1, the configuration of a printing system 1 of the invention is described. FIG. 1 is an overview diagram showing the configuration of the printing system 1 of the invention.

As shown in FIG. 1, the printing system 1 is configured to include printing command devices 2A to 2C, a printer server 3, and printing devices 4A to 4C. The printing command devices 2A to 2C each generate printing data including a printing command that is issued with respect to any specific printing device. The generated printing data is forwarded to the printer server 3. The printer server 3 receives the printing data provided by the printing command devices 2A to 2C, and distributes the printing data to a printing device that is the distribution destination directed by the printing command. The printer server 3 then allocates and distributes the not-yet-completed part of the printing process of the printing data to any other printing devices based on allocation request information coming from the printing device. The printing devices 4A to 4C each execute the printing process based on the printing data.

The printing command devices 2A to 2C each serve to create document data and image data using editors such as document editors, image editors, and others. The printing command devices 2A to 2C also each serve to convert the document data and the image data into the intermediate language for a printing process, e.g., PDL, and generate printing data. The printing data includes, at a header part, information about a user who issues a printing command, information about the number of printing copies, IP address information of a printing device that is a printing destination, and the like. The generated printing data is forwarded to the printer server 3. In FIG. 1, the printing system 1 is provided with three printing command devices of 2A to 2C. The number of printing command devices is not restricted, and two or fewer, or four or more printing devices will do. The details will be described later.

The printer server 3 receives the printing data coming from the printing command devices 2A to 2C, and analyzes the printing data. The printing data is then distributed to a printing device indicated by transmission destination information included in the header. The printer server 3 acquires, from the printing devices 4A to 4C, capability information indicating their each performance capability, and receives allocation request information coming from any of the printing devices 4A to 4C that is not currently in operation. Based on the received allocation request information and acquired capability information, the not-yet-processed part of the printing data currently subjected to the printing process is allocated and distributed, for operation, among a plurality of printing devices with an allocation rate in accordance with their respective capabilities. The detailed configuration will be described later.

The printing devices 4A to 4C receive the printing data coming from the printer server 3, and subject the received printing data to a printing process. The printing devices 4A to 4C also transmit their own capability information in accordance with an acquisition request coming from the printer server 3 for the capability information, or acquire allocation request information for transmission to the printer server 3. In response to the acquisition request coming from the printer server 3 for the printing process status information, the printing devices 4A to 4C transmit the printing status information, or if any printing device suffers from an error, the device transmits information about the error to the printer server 3. In FIG. 1, the printing system 1 is provided with three printing devices of 4A to 4C. The number of printing devices is not restricted, and two or fewer, or four or more printing devices will do. The detailed configuration will be described later.

A network 5 is a known information communications network exemplified by LAN or WAN, and over this network 5, the above-described devices perform data transmission and reception thereamong.

By referring to FIG. 2, described next is the detailed configuration of the printing command devices 2A to 2C. The printing command devices 2A to 2C share the same capabilities and configuration, and when there is no need for specific distinction thereamong, a description is made collectively as the printing command device 2. FIG. 2 is a block diagram showing the detailed configuration of the printing command device 2.

As shown in FIG. 2, the printing command device 2 is configured to include a data communications section 2a, a data control section 2b, a data storage section 2c, and a printing data generation section 2d.

The data communications section 2a serves to perform data transmission and reception with the devices connected over the network 5, e.g., transmits the printing data to the printer server 3 over the network 5.

The data control section 2b serves to collectively control the data flow in the printing command device 2. For example, the data control section 2b acquires data from external devices via the data communications section 2a for storage in the data storage section 2c, forwards various types of data stored in the data storage section 2c to each corresponding components, exercises control over data transmission and reception among the components, and transmits the printing data generated by the printing data generation section 2d to the printer server 3 via the data communications section 2a.

The data storage section 2c serves to store any data needed for processing in the components, including data for generating document data and image data by editors or others as a basis of the printing data, the resulting document data and image data, information for generating the printing data, or others.

Based on a printing command coming from editors or others generating document data and image data, the printing data generation section 2d converts the description language of such data into page description language such as PDL. The printing data generation section 2d also generates printing data through addition of information about the number of printing copies or the printing device as a printing destination. Once the printing data is generated as such, the printing data is forwarded to the printer server 3 via the data control section 2b.

The printing command device 2 is provided with a processor, RAM (Random Access Memory), and ROM (Read Only Memory) storing a specific program, none of which are shown. By the processor executing the program, the components serve as programmed. As to the components, some serve as programmed only by the specific program, or some serve as programmed through control over the hardware by the specific program.

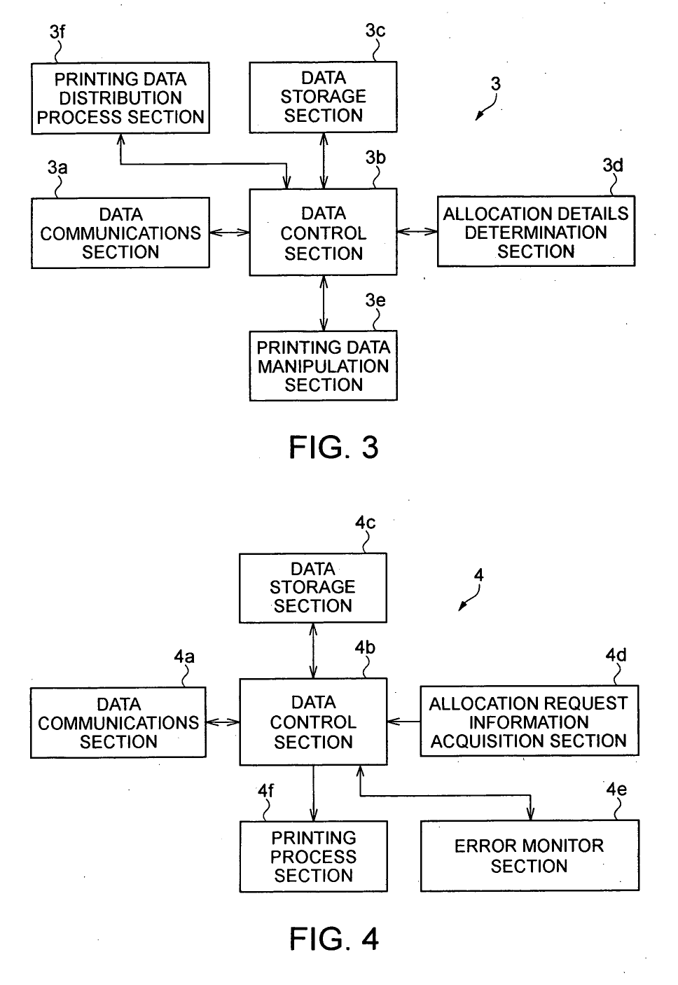

By referring to FIG. 3, described next is the detailed configuration of the printer server 3. FIG. 3 is a block diagram showing the detailed configuration of the printer server 3.

As shown in FIG. 3, the printer server 3 is configured to include a data communications-section 3a, a data control section 3b, a data storage section 3c, an allocation details determination section 3d, a printing data manipulation section 3e, and a printing data distribution process section 3f.

The data communications section 3a serves to perform data transmission and reception among the devices connected to one another over the network 5. For example, the data communications section 3a receives printing data coming from the printing command device 2 over the network 5, forwards acquisition requests to the devices over the network 5 for various types of information including capability information, printing status information, or others. The data communications section 3a also receives responses against the acquisition requests coming from the devices over the network 5.

The data control section 3b serves to collectively control the data flow in the printing server 3. For example, the data control section 3b receives various types of data from external devices such as the printing command devices 2A to 2C, the printing devices 4A to 4C, or others, via the data communications section 3a for storage in the data storage section 3c, forwards the data stored in the data storage section 3c to each corresponding components, and relay controls data transmission and reception among the components. Upon reception of a distribution command coming from the printing data distribution process section 3f, the data control section 3b responsively transmits the printing data to any corresponding printing device of those 4A to 4C via the data communications section 3a, or upon reception of a command coming from the allocation details determination section 3d, forwards to the printing devices 4A to 4C acquisition requests for the capability information or for the printing status information via the data communications section 3a.

In addition to the data and information received via the data communications section 3a, e.g., the printing data, the capability information, the allocation request information, the printing status information, or others, the data storage section 3c serves to store various other data needed for processing.

The allocation details determination section 3d analyzes the allocation request information coming from any of the printing devices 4A to 4C. The analysis result is used as a basis to acquire the printing process status information from the printing device currently in operation, i.e., during the printing process for the printing data. The printing process status information is the one indicating the current status of the printing process for the printing data corresponding to the allocation request information. Based on all the printing status information, the capability information of the printing device and another printing device designated as an allocation destination, and the error information, the allocation details determination section 3d serves to determine the allocation details for the not-yet-completed part of the printing process.

The printing data manipulation section 3e serves to generate manipulated printing data based on the allocation details determined by the allocation details determination section 3d. The manipulated printing data is generated by manipulating information in the header part of the printing data. The generated manipulated printing data is forwarded to the printing device designated as the allocation destination via the printing data distribution process section 3f.

The printing data distribution process section 3f serves to distribute, via the data communications section 3a, the printing data coming from the printing command devices 2A to 2C to the printing device designated as a transmission destination of the printing data. The printing data distribution process section 3f also serves to distribute, via the data communications section 3a, the manipulated printing data generated by the printing data manipulation section 3e to the printing device designated as a transmission designation of the manipulated printing data. Note that, although the printing data manipulated by the printing data manipulation section 3e is referred to as manipulated printing data in the present embodiment, the manipulated printing data has the same data configuration as the printing data to be generated by the printing command device 2. Therefore, no distinction will be made therebetween on the end of the printing device 4.

The printer server 3 is provided with a processor, RAM (Random Access Memory), and ROM (Read Only Memory) storing a specific program, none of which are shown. By the processor executing the program, the components serve as programmed. As to the components, some serve as programmed only by the specific program, or some serve as programmed through control over the hardware by the specific program.

By referring to FIG. 4 described next is the detailed configuration of the printing devices 4A to 4C. The printing command devices 4A to 4C share the same capabilities and configuration, and when there is no need for specific distinction thereamong, a description is made collectively as the printing device 4. FIG. 4 is a block diagram showing the detailed configuration of the printing device 4.

As shown in FIG. 4, the printing device 4 is configured to include a data communications section 4a, a data control section 4b, a data storage section 4c, an allocation request information acquisition section 4d, an error monitor section 4e, and a printing process section 4f.

The data communications section 4a serves to perform data transmission and reception with the printer server 3. For example, the data communications section 4a receives various types of data coming from the printer server 3 over the network 5, e.g., acquisition requests for capability information, acquisition requests for printing process status information, printing data, and others. The data communications section 4a also forwards various types of information to the printer server 3 over the network 5, e.g., allocation request information, capability information, printing status information, or others.

The data control section 4b serves to collectively control the data flow in the printing device 4. For example, the data control section 4b stores the data received from the printer server 3 in the data storage section 4c via the data communications section 4a, forwards the data stored in the data storage section 4c to the corresponding components, relay controls data transmission and reception among the components, or acquires, for transmission to the printer server 3, various types of information in accordance with the acquisition requests received from the printer server 3 for various information.

The data storage section 4c serves to store the data received via the data communications section 4a, e.g., printing data, data needed for processing, or others.

The allocation request information acquisition section 4d is provided with a card reader for magnetic cards. When the reader reads information about a user's magnetic card, the read information is used as a basis to generate allocation request information, which is required for transmission to the printer server 3. Hereinafter, the information of the user's magnetic card is referred to as first allocation request information, and the allocation request information is referred to as second allocation request information. The allocation request information acquisition section 4d serves to transmit the second allocation request information to the printer server 3 via both the data control section 4b and the data communications section 4a. In the present embodiment, the printing device 4 that has read the magnetic card is authenticated as an allocation destination, thereby generating the second allocation request information indicating that the printing device is an allocation destination.

The error monitor section 4e monitors the printing devices for possible errors, e.g., paper jamming, paper-out condition, or others. When such an error occurs, error information is generated for transmission to the printer server 3 via both the data control section 4b and the data communications section 4a.

Based on the printing data stored in the data storage section 4c, the printing process section 4f serves to execute the printing process to documents including images of image data, documents of document data as a part of the printing data. In the present embodiment, a toner ink is used for printing of images and documents on printing paper.

The printing device 4 is provided with a processor, RAM (Random Access Memory), and ROM (Read Only Memory) storing a specific program, none of which are shown. By the processor executing the program, the components serve as programmed. As to the components, some serve as programmed only by the specific program, or some serve as programmed through control over the hardware by the specific program.

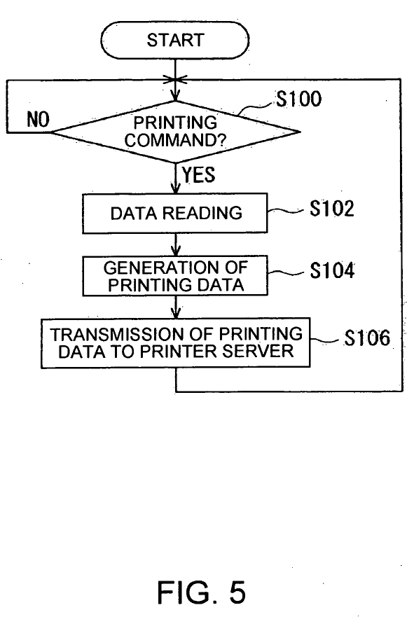

In the printing command device 2, the CPU starts a predetermined program stored in a predetermined region of the ROM, and in accordance with the program, a printing command process of the flowchart of FIG. 5 is executed.

FIG. 5 is a flowchart of a printing command process in the printing command device 2.

As shown in FIG. 5, once the CPU starts the printing command process, the procedure first goes to step S100.

In step S100, in the data control section 2b, a determination is made whether a printing command is issued by an editor. When a printing command is determined as being issued (Yes), the procedure goes to step S102, and when not (No), the system is put on standby until a printing command comes.

In step S102, in the printing data generation section 2d, data is read from the data storage section 2c via the data control section 2b, and the procedure goes to step S104. The data includes data created by an editor corresponding to the printing command, information about a log-in user of the printing command device, or others.

In step S104, in the printing data generation section 2d, the data read in step S102 is used as a basis to generate printing data. The procedure then goes to step S106.

In step S106, in the printing data generation section 2d, the printing data generated in step S104 is forwarded to the printer server 3 via both the data control section 2b and the data communications section 2a. The procedure then goes to step S100.

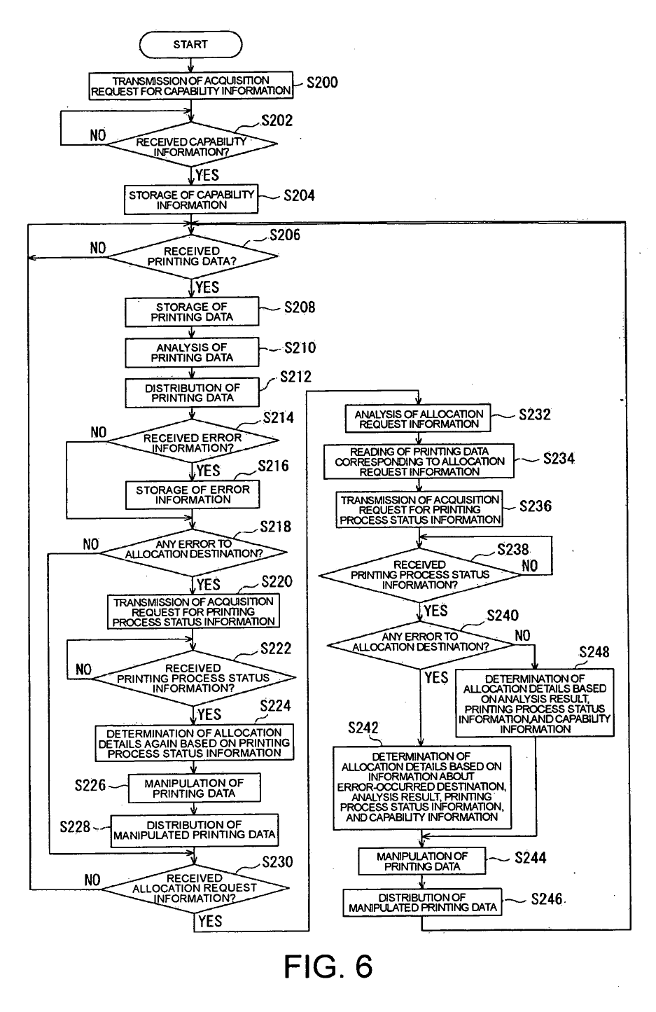

In the printer server 3, the CPU starts a predetermined CPU stored in a predetermined region of the ROM, and in accordance with the program, a printing allocation process of the flowchart of FIG. 6 is executed.

FIG. 6 is a flowchart of the printing allocation process in the printer server.

As shown in FIG. 6, once the CPU executes the printing allocation process, the procedure first goes to step S200.

In step S200, in the data control section 3b, an acquisition request for the capability information is forwarded to the printing devices 4A to 4C via the data communications section 3a. The procedure then goes to step S202.

In step S202, in the data communications section 3b, a determination is made whether the capability information is provided by the printing devices 4A to 4C via the data communications section 3a. When the capability information is determined as being received (Yes), the procedure goes to step S204, and when not (No), the system is put on standby until the capability information comes.

In step S204, in the data control section 3b, the capability information received in step S202 is stored in the data storage section 3c, and the procedure then goes to step S206.

In step S206, in the data control section 3b, a determination is made whether the printing data is provided by the printing command devices 2A to 2C. When the printing data is determined as being received (Yes), the procedure goes to step S208, and when not (No), the system is put on standby until the printing data comes.

In step S208, in the data control section 3b, the printing data received in step S206 is stored in the data storage section 3c, and the procedure then goes to step S210.

In step S210, in the data control section 3b, the printing data stored in the data storage section 3c is analyzed, and the procedure then goes to step S212. Here, analyzing the printing data is a process of extracting information in the header part of the printing data, e.g., information about a user who issues a printing command, information about a printing device designated as a transmission destination, and others. The printing data is processed generally in the order of reception. This is surely not restrictive, and when the header part of the printer data carries information indicating the precedence, the printing data of a higher precedence will be processed with a priority.

In step S212, based on the analysis result derived in step S210, in the printing data distribution process section 3f, the analyzed printing data is distributed to the printing device designated as a transmission destination of the printing data via the data control section 3b and the data communications section 3a. The procedure then goes to step S214.

In step S214, in the data control section 3b, a determination is made whether the error information is provided by any of the printing devices 4A to 4C. When the error information is determined as being received (Yes), the procedure goes to step S216, and when not (No), the procedure goes to step S218.

In step S216, in the data control section 3b, the error information received in step S214 is stored in the data storage section 3c, and the procedure then goes to step S218.

In step S218, based on the error information stored in the data storage section 3c, in the data control section 3b, a determination is made whether any error is occurring to the printing device designated as an allocation destination. When an error is determined as occurring (Yes), the procedure goes to step S220, and when not (No), the procedure goes to step S230. In the present embodiment, when the printing device is through with printing, a printing completion notice is supposed to be issued from the printing device, and this notice is used as a determination factor to see whether printing is yet in progress or not. Accordingly, when the error information is provided during printing by the printing device, it means that the printing process is being interrupted due to error occurrence.

In step S220, in the allocation details determination section 3d, an acquisition request is forwarded to the allocation-destination printing device together with the error-inflicted printing device via the data control section 3b and the data communications section 3a, and the procedure then goes to step S222. Herein, the acquisition request is made for the printing process status information, which indicates the printing process status of the printing data to deal with the error occurrence.

In step S222, in the data control section 3b, a determination is made whether the printing process status information is received. When the printing process status information is determined as being received (Yes), the procedure goes to step S224, and when not (No), the system is put on standby until the printing process status information comes.

In step S224, based on the information about the error-inflicted printing device and the printing process status information received in step S222, in the allocation details determination section 3d, a determination is made again about the allocation details. The procedure then goes to step S226.

In step S226, based on the allocation details determined again in step S224, in the printing data manipulation section 3e, the corresponding printing data is manipulated so that manipulated printing data is generated. The procedure then goes to step S228.

In step S228, in the printing data distribution process section 3f, the manipulated printing data generated by the printing data manipulation section 3e is distributed to the printing device designated as the allocation destination via the data control section 3b and the data communications section 3a. The procedure then goes to step S230.

In step S230, in the data control section 3b, a determination is made whether the second allocation request information is provided by the printing devices 4A to 4C. When the second allocation request information is determined as being received (Yes), the procedure goes to step S232, and when not (No), the procedure goes to step S206.

In step S232, in the allocation details determination section 3d, the second allocation request information received in step S230 is analyzed, and the procedure then goes to step 234. Here, analyzing the second allocation request information is a process of extracting information about the printing device being the allocation destination, information about the printing data in charge, e.g., user name and data title, or others.

In step S234, based on the analysis result derived in step S232, in the allocation details determination section 3d, the printing data corresponding to the second allocation request information is read from the data storage section 3c via the data control section 3b. The procedure then goes to step S236.

In step S236, in the allocation details determination section 3d, an acquisition request is forwarded, via the data control section 3b and the data communications section 3a, to the allocation-destination printing device that is currently in the printing process for the printing data read in step S234. Herein, the acquisition request is made for the printing process status information, which indicates the printing process status of the printing data. The procedure then goes to step S238.

In step S238, in the data control section 3b, a determination is made whether the printing process status information is received or not. When the information is determined as being received (Yes), the procedure goes to step S240, and when not (No), the system is put on standby until the printing process status information comes.

In step S240, in the allocation details determination section 3d, the error information is read from the data storage section 3c via the data control section 3b, and a determination is then made whether any error is occurring to the printing device being the allocation destination. When an error is determined as occurring (Yes), the procedure goes to step S242, and when not (No), the procedure goes to step S248.

In step S242, in the allocation details determination section 3d, a determination is made about the allocation details for the not-yet-processed part of the printing data read in step S234. For such a determination, used as a basis are information about the error-inflicted printing device, the analysis result derived in step S232, the capability information about the allocation-destination printing device stored in the data storage section 3c, and the printing process status information received in step S238. The procedure then goes to step S244.

In step S244, based on the allocation details determined in step S240, in the printing data manipulation section 3e, the printing data read in step S234 is manipulated so that manipulated printing data is generated. The procedure then goes to step S246.

In step S246, in the printing data distribution process section 3f, the manipulated printing data generated by the printing data manipulation section 3e is distributed to the printing device being the allocation destination via the data control section 3b and the data communications section 3a. The procedure then goes to step S206.

In step 248, in the allocation details determination section 3d, a determination is made about the allocation details for the not-yet-processed part of the printing data read in step S234. For such a determination, used as a basis are the analysis result derived in step S232, the capability information about the allocation-destination printing device stored in the data storage section 3c, and the printing process status information received in step S238. The procedure then goes to step S244.

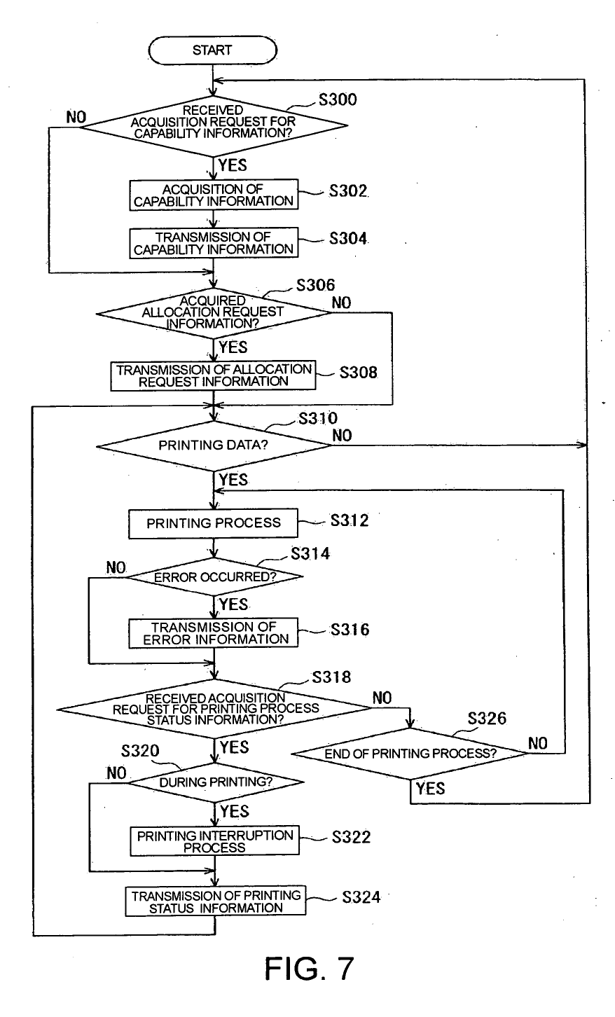

In the printing device 4, the CPU starts a predetermined program stored in a predetermined region in the ROM, and in accordance with the program, a printing process of the flowchart of FIG. 7 is executed.

FIG. 7 is a flowchart of the printing process in the printing device 4.

As shown in FIG. 7, when the CPU starts executing the printing process, the procedure first goes to step S300.

In step S300, in the data control section 4b, a determination is made whether an acquisition request for capability information is provided by the printer server 3. When such an acquisition request is determined as being received (Yes), the procedure goes to step S302, and when not (No), the procedure goes to step S306.

In step S302, in the data control section 3b, the capability information of its own is acquired, and the procedure then goes to step S304. In the present embodiment, acquiring the capability information is a process of reading the capability information of its own previously stored in the data storage section 4c.

In step S304, in the data control section 4b, the capability information acquired in step S302 is forwarded to the printer server 3 via the data communications section 4a. The procedure then goes to step S306.

In step S306, in the allocation request information acquisition section 4d, a determination is made whether first allocation request information is acquired. When the first allocation request information is determined as being acquired (Yes), the procedure goes to step S308, and when not (No), the procedure goes to step S310.

In step S308, based on the first allocation request information acquired in step S306, in the allocation request information acquisition section 4d, the second allocation request information is generated for transmission to the printer server 3 via the data control section 4b and the data communications section 4a. The procedure then goes to step S310.

In step S310, in the data control section 4b, a determination is made whether the data storage section 4c carries therein the printing data. When the printing data is determined as being stored (Yes), the procedure goes to step S312, when not (No), the procedure goes to step S300. In the present embodiment, the printing data is assumed as being always received and stored in the data storage section 4c, and when printing is in progress, the printing data is to be accumulated in the data storage section 4c.

In step S312, in the printing process section 4f, the printing data stored in the data storage section 4c is read, and based on the printing data, the printing process is executed. The procedure then goes to step S314.

In step S314, in the error monitor section 4e, a determination is made whether any error is occurring to the printing device of its own. When an error is determined as occurring (Yes), the procedure goes to step S316, and when not (No), the procedure goes to step S318.

In step S316, in the error monitor section 4e, error information including the information about the printing device of its own is generated. The generated error information is forwarded to the printer server 3 via the data control section 4b and the data communications section 4a. The procedure then goes to step S318.

In step S318, in the data control section 4b, a determination is made whether an acquisition request for the printing process status information is provided by the printer server 3. When the acquisition request is determined as being received (Yes), the procedure goes to step S320, and when not (No), the procedure goes to step S326.

In step S320, in the data control section 4b, a determination is made whether the printing data corresponding to the acquisition request is currently subjected to the printing process. When the printing data is determined as being in the printing process (Yes), the procedure goes to step S322, and when not (No), the procedure goes to step S324.

In step S322, in the data control section 4b, an interruption process is executed for the printing process, and the procedure then goes to step S324. Herein, the interruption process is of interrupting the printing process currently in progress. If the printing process is halfway through, the process will be interrupted after the printing is through with the last page, or the printing process will be continued until barely before the time estimated for the process-allocated printing is started, for example.

In step S324, in the data control section 4b, the printing process status information is generated in accordance with the details of the interruption process. The generated printing process status information is forwarded to the printer server 3 via the data communications section 4a, and the procedure goes to step S314.

In step S318, when the procedure goes to step S326 without receiving the acquisition request for the printing process status information, in the data control section 4b, a determination is made whether the printing process is through or not (step S326). When the printing process is determined as being through (Yes), the procedure goes to step S300, and when not (No), the procedure goes to step S312.

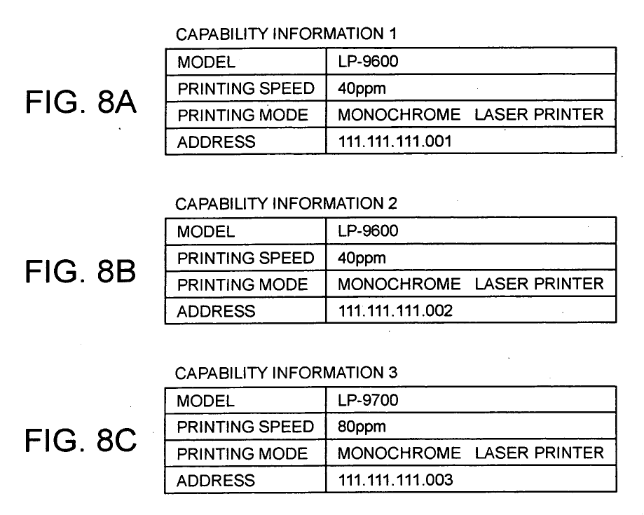

By referring to FIGS. 8A to 11D, described next is the operation of the present embodiment.

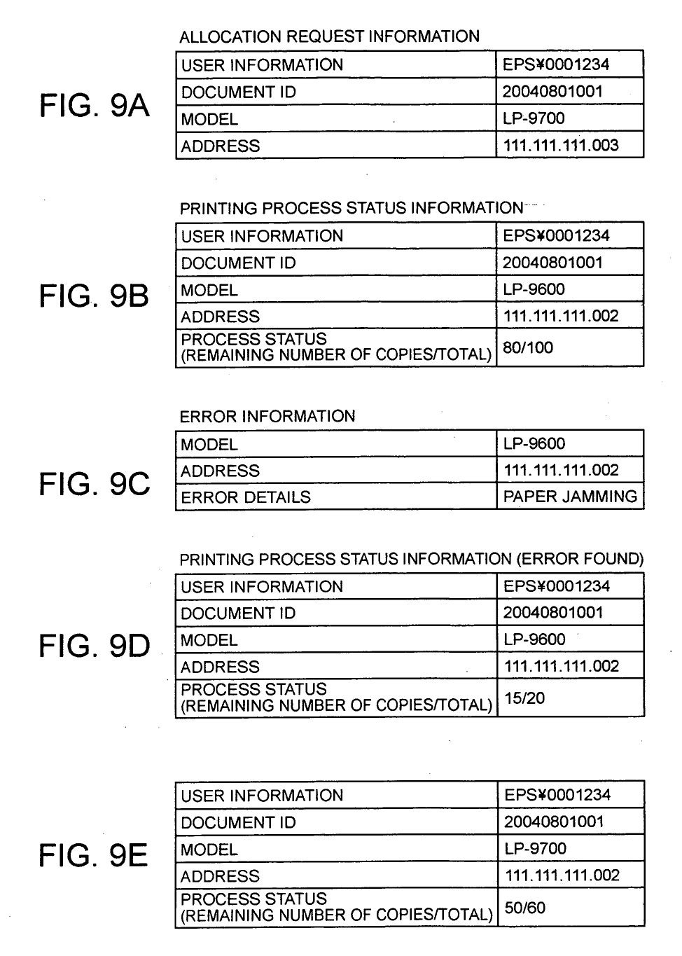

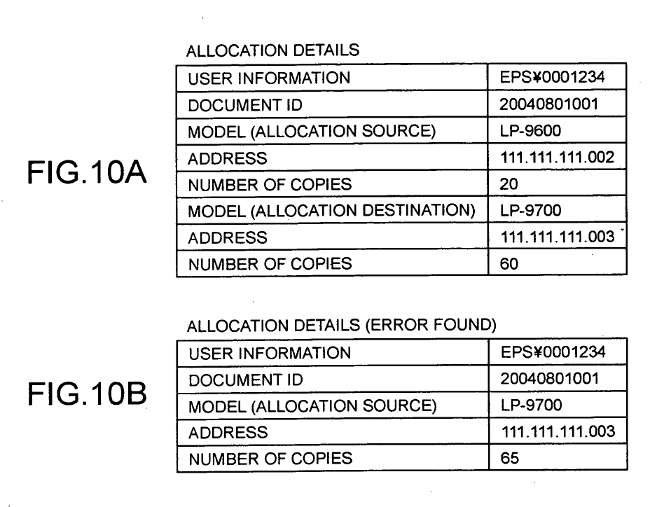

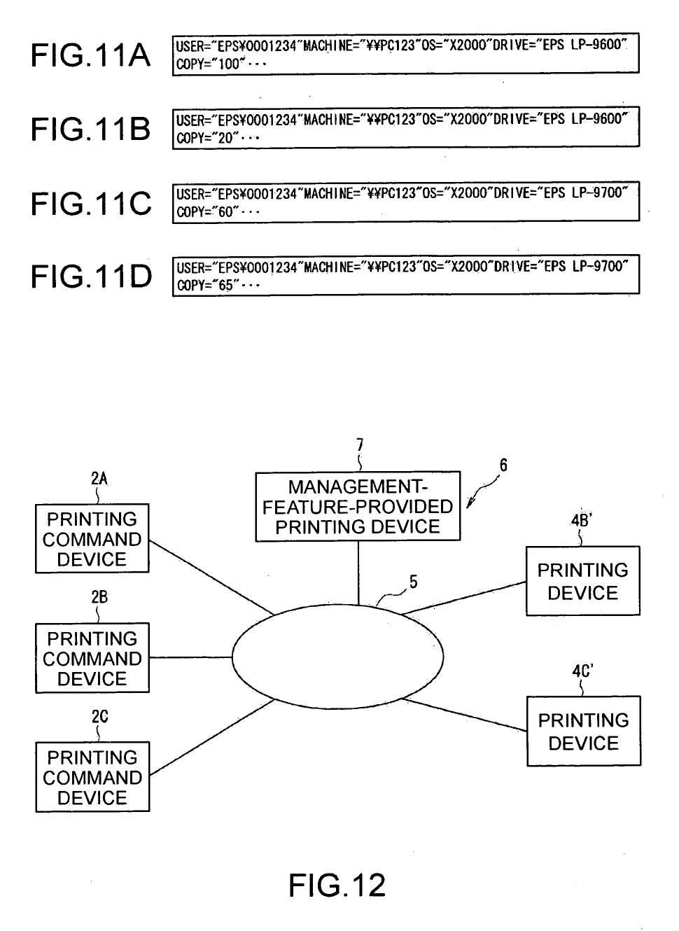

FIGS. 8A to 8C are all diagrams showing exemplary capability information to be provided by the printing devices 4A to 4C. FIG. 9A is a diagram showing exemplary allocation request information coming from the printing device 4, FIG. 9B is a diagram showing exemplary printing process status information coming from the printing device 4, FIG. 9C is a diagram showing exemplary error information coming from the printing device 4, and FIGS. 9D and 9E are both diagrams showing exemplary printing process status information at the time of error occurrence. FIG. 10A is a diagram showing exemplary allocation details to be determined by the allocation details determination section 3d, and FIG. 10B is a diagram showing exemplary allocation details that are determined again due to error occurrence. FIG. 11A is a diagram showing exemplary header information of printing data before the allocation details are determined, FIGS. 10B and 10C are both diagrams showing exemplary header information of printing data that is manipulated based on the allocation details, and FIG. 10D is a diagram showing exemplary header information of printing data manipulated based on the allocation details that are determined again due to error occurrence.

In the printing command device 2, a printing command comes from a document editor or others (step Slob). The printing data generation section 2d then performs data reading from the data storage section 2c, e.g., document data, or user information (step S102) so that printing data is generated (step S104). The printing data is the one derived by converting the document data into page description language, and the converted data is added with header information. The header information includes user's information, information about the printing command device, information about OS (Operating System), information about a printing device being a transmission destination, information about the number of printing copies, and others.

The resulting printing data is forwarded to the printer server 3 via the data control section 2b and the data communications section 2a (step S106).

In the printer server 3, immediately after the power is turned ON, the data control section 3b forwards an acquisition request to the printing devices 4A to 4C via the data communications section 3a, asking for their capability information (step S200). The printing devices 4A to 4C are all connected over the network 5.

When the printing devices 4A to 4C receive the acquisition request coming from the printer server 3 via the data communications section 4a asking for their capability information (step S300), the data control section 4b reads the capability information stored in the data storage section 4c (step S302), and the information is forwarded to the printer server 3 via the data communications section 3a (step S304). As shown in FIGS. 8A to 8C, the capability information includes the model of the printing device, printing speed (ppm), printing mode, e.g., “monochrome laser printer” or “color ink jet printer”, IP address of the printing device on the network 5, or others. In the present embodiment, capability information 1 to 3 of FIGS. 8A to 8C correspond to the printing devices 4A to 4C, respectively. As shown in FIG. 8A, the printing device 4A is of “LP-9600” model, “40 ppm” in printing speed, “monochrome laser printer” in printing mode, and IP address of “111. 111. 111. 001”.

After the printing devices 4A to 4C forward the capability information, the printer server 3 receives the capability information via the data communications section 3a (step S202), and stores the received capability information in the data storage section 3c (step S204).

After the printer server 3 receives the printing data coming from the printing command device 2 via the data communications section 3a (step S206), the printing data is stored in the data storage section 3c (step S208). The stored printing data is then analyzed by the data control section 3b (step S210), and based on the analysis result, the printing data distribution process section 3f distributes the printing data toward the printing device being the transmission destination (step S212). Here, analyzing the printing data is a process of extracting, from the header information, information about the printing device being the transmission destination.

After receiving the printing data coming from the printer server 3 via the data communications section 4a, the printing device 4 stores the printing data in the data storage section 4c. When no printing data is currently in the printing process, the printing process section 4f selects the printing data stored in the data storage section 4c as target data for the printing process. The selected printing data is then subjected to the printing process (step S312). Here, the printing process is of printing documents and images of the printing data onto printing paper. The printing data is repeatedly subjected to the printing process for the number of copies for printing found in the header information.

In the printing device 4, the error monitor section 4e is continuously monitoring the printing device for possible errors, e.g., paper jamming, or others. When error occurrence is detected, error information is generated for transmission to the printer server 3 via the data communications section 4a. In the present embodiment, as shown in FIG. 9C, the error information includes model of the printing device, IP address, and information about error details. For example, the error information of FIG. 9C is about the error occurred in the printing device 4B, and indicating that “paper jamming” is caused thereby.

The printer server 3 receives the error information coming from the printer device 4 for storage into the data storage section 3c. At this time, when any other error information is found for the same printing device, the error information is accordingly updated.

After a user issues a printing command with respect to the printing command device 2 for the data created by an editor or others, the user writes information about the printing-requested data into any specific magnetic card. For such information writing, used is a card writer that is not shown but is connected to the printing command device 2. Such information is hereinafter referred to as document ID. The magnetic card is provided in advance with information for use for user identification, i.e., card holder. If the user finds any available printing device 4 other than the printing device 4 being the addressee of the printing command, the user makes the card reader of the printing device 4 read the magnetic card carrying therein the document ID. That is, the user's identification information and the document ID are the first allocation request information, and the printing device 4 reads the first allocation request information from the user's magnetic card using the card reader provided to the allocation request information acquisition section 4d (step S306). The read first allocation request information is added with the model of the printing device, and the information about the IP address so that the second allocation request information is generated. The resulting second allocation request information is forwarded to the printer server 3 via the data communications section 4a (step S308).

After the second allocation request information is forwarded from the printing device 4, the printer server 3 receives the second allocation request information via the data communications section 3a (step S230). The received second allocation request information is then analyzed in the allocation details determination section 3d (step S232). Based on the analysis result, the printing data corresponding to the second allocation request information is read from the data storage section 3c (step S234). With respect to the printing device 4 that is currently being in the printing process for the read printing data, the printer server 3 forwards an acquisition request via the data communications section 3a for the printing process status information of the printing data (step S236). In the present embodiment, the acquisition request for the printing process status information includes the document ID.

After the acquisition request comes from the printer server 3 for the printing process status information, the printing device 4 being the transmission destination receives the acquisition request via the data communications section 4a (step S318). When the corresponding printing data is currently in the printing process (step S320), the interruption process is executed for the printing process (step S322). Based on the details of the interruption process, the printing process status information is generated for transmission to the printer server 3 via the data communications section 4a (step S324). In the present embodiment, as shown in FIG. 9B, the printing process status information includes information about a user who issues a printing command, document ID, model of the printing device, IP address, and information indicating the process status. Herein, the interruption process is of interrupting the printing process currently in progress. Assume that an acquisition request comes for the printing process status information in a process of printing 100 copies. In this case, if printing of the 20th copy is halfway through, the printing process will be interrupted after the printing of the 20th copy is completed. The printing data may be discarded. The printing process status information is so generated as to indicate the remaining number of copies is 80 for transmission to the printer server 3.

After the printing process status information is forwarded from the printing device 4, the printer server 3 receives the printing process status information via the data communications section 3a (step S238). The printer server 3 then checks the storage contents of the data storage section 3c whether any error is occurring to the allocation-destination printing device 4 being the source of the second allocation request information (step S240). When no error is observed, the allocation details determination section 3d determines the allocation details in which the printing device 4 being the source of the second allocation request information is the allocation destination (step S248). Described here is a case where a user A uses the printing command device 2A to forward printing data for the printing device 4B to the printer server 3. The printing device 4B responsively starts the printing process, and the user A makes the card reader of the currently-available printing device 4C read a magnetic card. In this case, presumably, the header information of the printing data tells that the number of copies is 100. The second allocation request information coming from the printing device 4B has the contents of FIG. 9A, and the printing status information coming from the printing device 4B has the contents of FIG. 9B. Accordingly, as shown in FIG. 9A, the second allocation request information includes “EPS0001234” as user information, “20040801001” as document ID, “LP-9700” as model, and “111. 111. 111. 003” as IP address. As shown in FIG. 9B, the printing process status information includes “EPS0001234” as user information, “20040801001” as document ID, “LP-9600” as model, “111. 111. 111. 002” as IP address, and “80/100” as process status. Herein, the process status “80/100” of FIG. 9B indicates that 80 copies are not yet through out of 100 copies, i.e., 20 copies are through with printing in the printing device 4B.

Based on the second allocation request information of FIG. 9A and the printing process status information of FIG. 9B, and the capability information of the printing devices 4B and 4C stored in the data storage section 3c, the printer server 3 determines the allocation details for the printing devices 4B and 4C, i.e., allocation ratio of the remaining 80 copies. In the present embodiment, as shown in FIGS. 8B and 8C, the printing speed of the printing device 4C is twice as that of the printing device 4B. It means that the throughput of the printing device 4C is higher than that of the printing device 4B so that the more number of printing copies is allocated to the printing device 4C. With this exemplary allocation details, as shown in FIG. 10A, the printing device 4B is allocated with 20 copies out of the remaining 80 copies, and the printing device 4C with 60 copies.

When the allocation details determination section 3d determines the allocation details, the printing data manipulation section 3e executes a manipulation process for the printing data based on the determined allocation details (step S242). In the present embodiment, manipulating the printing data is of rewriting the header part of the printing data in accordance with the allocation details. As shown in FIG. 11B, as the printing data for the printing device 4B, in the header information of the original printing data of FIG. 11A, the part of “COPY=“100”” indicating the number of printing copies is rewritten as “COPY=”20””, and the resulting data is manipulated printing data B. On the other hand, as the printing data for the printing device 4C, in the header information of the original printing data of FIG. 11A, the part of “DRIVE=“EPS LP-9600”” indicating the (driver) type of the printing device is rewritten as “DRIVE=“EPS LP-9700””, and the part of “COPY=“100”” indicating the number of printing copies is rewritten as “COPY=“60””. The resulting data is manipulated printing data C.

After the manipulated printing data is generated for the allocation destination, the printing data distribution process section 3f distributes, via the data communications section 3a, the manipulated printing data B to the printing device 4B, and the manipulated printing data C to the printing device 4C (step S246).

After the printing devices 4B and 4C receive the manipulated printing data B and C, respectively, via the data communications section 4a, the printing process section 4f subjects the manipulated printing data B and C to the printing process.

Until the printing devices 4B and 4C are through with the printing process after process allocation, the printer server 3 keeps referring to the error information stored in the data storage section 3c to determine whether any error is occurring to the printing devices being the allocation destination (step S218). When any error is occurring to such allocation destinations, e.g., the error information of FIG. 9C is found in the data storage section 3c, the printer server 3 forwards an acquisition request to the printing devices 4B and 4C for the printing process status information (step S220). Upon reception of the acquisition request for the printing process status information, the printing devices 4B and 4C forward, to the printer server 3, the printing process status information of FIGS. 9D and 9E, respectively.

After the printer server 3 receives the printing process status information from the printing devices 4B and 4C, the allocation details determination section 3d determines again the allocation details based on the error information about the error-inflicted allocation destination, and the printing process status information of the printing devices 4B and 4C (step S224). In this example, the error information tells that an error is observed in the printing device 4B. In the present embodiment, as shown in FIG. 9D, the printing device 4B is not yet through with 15 copies out of 20 copies in charge, and as shown in FIG. 9E, the printing device 4C is not yet through with 50 copies out of 60 copies in charge. Therefore, as shown in FIG. 10B, the printing device 4C is put in charge for the not-yet-printed 65 copies in total. Once such allocation details are determined, as shown in FIG. 11D, the printing data manipulation section 3e changes the number of copies in the printing data after process allocation into “COPY=“65”” so that new manipulated printing data C is generated (step S226). After the manipulated printing data C is generated as such, the printing data distribution process section 3f distributes the manipulated printing data C to the printing device 4C via the data communications section 3a (step S228).

When the allocation details determination section 3d determines the allocation details, if an error is occurring in the printing device being the transmission source of the second allocation request information, the printing process is allocated among the remaining printing devices not including the error-occurring allocation destination (step S242). For example, when one of two printing devices is suffering from an error before process allocation, the allocation details are so determined that printing copies are entirely allocated to the printing device not suffering from the error. Alternatively, when the error-inflicted printing device 4 is designated as an allocation destination when the allocation details are determined, such a determination process for the allocation details may be skipped.

Only such a simple operation as making a printing device read information written in a magnetic card, i.e., user information and document ID, enables the parallel processing. More in detail, a magnetic card is provided, for data reading, to a printing device that is separately provided from a printing device that is currently in a printing process for the printing data. This enables parallel processing for the not-yet-completed part of the printing process between the printing device currently in the printing process, and the printing device that has read the magnetic card.

What is more, the allocation details determination section 3d becomes possible to determine the allocation details for the printing process based on the performance capabilities of the printing devices designated as allocation destinations. Accordingly, the throughput of the printing process can be used as a basis for allocation of printing copies, and therefore the allocation-destination printing devices can go through the printing process with efficiency.

Moreover, by monitoring the printing devices for any error, and even if an error is observed, the error-inflicted printing device is allocated with no printing process. If an error is observed during the printing process, the allocation details are to be determined again so that the printing process can be always completed even with the error occurrence.

In the above first embodiment, the process of receiving the second allocation request information from the printing device 4 via the data communications section 3a and the data control section 3b, and storing the received second allocation request information in the data storage section 3c is corresponding to the allocation request information acquisition unit of the eleventh or sixteenth aspect. The process of transmitting the acquisition request for the printing status information to the printing device 4 via the data communications section 3a and the data control section 3b is corresponding to the acquisition request transmission unit of the twenty-first or twenty-second aspect. The process of receiving the printing status information from the printing device 4 via the data communications section 3a and the data control section 3b, and storing the received printing status information in the data storage section 3c is corresponding to the printing process status information acquisition unit of the eleventh or sixteenth aspect. The process of analyzing the printing data coming from the printing command device 2 via the data communications section 3a and the data control section 3b, and transmitting the printing data to the transmission-destination printing device 4 is corresponding to the printing data transmission unit of the eleventh or sixteenth aspect.

Also in the above first embodiment, the process of receiving the error information from the printing device 4 via the data communications section 3a and the data control section 3b, and storing the received error information in the data storage section 3c is corresponding to the error information acquisition unit of the thirteenth or eighteenth aspect.

Also in the above first embodiment, the process of transmitting the acquisition request for the capability information to the printing device 4 via the data communications section 3a and the data control section 3b, receiving the capability information from the printing device 4, and storing the received capability information in the data storage section 3c is corresponding to the capability information acquisition unit of the fourteenth or nineteenth aspect.

Also in the above first embodiment, the process of receiving the printing data corresponding to the second allocation request information from the data storage section 3c is corresponding to the allocation printing data acquisition unit of the eleventh or sixteenth aspect. The allocation details determination section 3d is corresponding to the allocation details determination unit of any one of the eleventh to twentieth aspects. The printing data manipulation section 3e is corresponding to the printing data manipulation unit of the eleventh or sixteenth aspect. The process of distributing the manipulated printing data by the printing data distribution process section 3f, the data control section 3b, and the data communications section 3a is corresponding to the manipulated printing data transmission unit of the eleventh or sixteenth aspect.

Also in the above first aspect, the process of receiving the printing data (manipulated printing data included) from the printer server 3 via the data communications section 4a and the data control section 4b, and storing the received printing data in the data storage section 4c is corresponding to the unit data acquisition unit of any one of the eleventh, sixteenth, and twenty-third aspects. The process of transmitting the printing status information to the printer server 3 via the data communications section 4a and the data control section 4b is corresponding to the printing process status information transmission unit of the twenty-third aspect. The printing process section 4f is corresponding to the printing process unit of the twenty-third aspect, and the allocation request information acquisition section 4d is corresponding to the allocation request information input unit of the twenty-third aspect.

Also in the above first embodiment, steps S200 to S204 correspond to the capability information acquisition step of the thirty-ninth or fifty-seventh aspect. Steps S206 and S208 correspond to the printing data acquisition step of the thirty-sixth or fifty-fourth aspect. Steps 210 and S212 correspond to the printing data transmission step of the thirty-sixth or fifty-fourth aspect. Steps S214 and S216 correspond to the error information acquisition step of the thirty-eighth or fifty-sixth aspect. Steps S220 and S222, and S236 and S238 correspond to the printing process status information acquisition step of the thirty-sixth or fifty-fourth aspect. Steps S224, S242 and S248 correspond to the allocation details determination step of any one of the thirty-sixth to fortieth, and fifty-fourth to fifty-eighth aspects. Step S230 corresponds to the allocation request information acquisition step of the thirty-sixth or fifty-fourth aspect. Step S234 corresponds to the allocation printing data acquisition step of the thirty-sixth or fifty-fourth aspect. Step S226 or S244 corresponds to the printing data manipulation step of the thirty-sixth or fifty-fourth aspect. Step S228 or S246 corresponds to the manipulated printing data transmission step of the thirty-sixth or fifty-fourth aspect.

Also in the above first embodiment, step S306 corresponds to the allocation request information input step of the forty-second or sixtieth aspect. Step S308 corresponds to the allocation request information transmission step of the forty-second or sixtieth aspect. Step S312 corresponds to the printing process step of the forty-second or sixtieth aspect. Steps S318 to S324 correspond to the printing process status information transmission step of the forty-second or sixtieth aspect.

### Second Embodiment

In the following, a second embodiment of the invention is described by referring to the accompanying drawings. FIGS. 12 to 19C are all diagrams showing the second embodiment of the invention, i.e., a printing management device, a printing-management-feature-provided printing device, a printing system, a printing device, a printing management program, a printing-management-feature-provided printing device control program, a printing device control program, a printing management method, a printing-management-feature-provided printing device control method, and a printing device control method.

Unlike the first embodiment, in the second embodiment, printing devices each serve as the printer server 3 in the first embodiment, printing data is subjected to a manipulation process copy by copy based on allocation details, and a user's authentication process is required for each of the respective printing devices to output the printing result.

By referring to FIG. 12, described next is the configuration of a printing system 6 of the invention. FIG. 12 is an overview diagram showing the configuration of the printing system 6 of the invention.

As shown in FIG. 12, the printing system 6 is configured to include the printing command devices 2A to 2C, a management-feature-provided printing device 7, printing devices 4B′ and 4C′, and the network 5. The printing command devices 2A to 2C each generate printing data including a printing command that is issued with respect to any specific printing device, and forwards the generated printing data to the management-feature-provided printing device 7. The management-feature-provided printing device 7 serves to: execute a printing process based on the printing data; receive the printing data coming from the printing command devices 2A to 2C, and distribute the printing data to a printing device that is designated as a distribution destination; and allocating the not-yet-processed part of the printing data among a plurality of printing devices based on allocation request information coming from the printing device.

In the following, only differences from the first embodiment are described, and any details already described in the above are not described again.

The printing command devices 2A to 2C operate differently from those in the first embodiment, i.e., generate printing data added with first personal identification information, and forward the generated printing data to the management-feature-provided printing device 7.

The management-feature-provided printing device 7 receives printing data coming from the printing command devices 2A to 2C, and takes charge of the following operations. That is, the management-feature-provided printing device 7 stores the received printing data, receives second allocation request information coming from a printing device that is not currently in the printing process, determines whether or not to subject allocation details to a determination process based on the second allocation request information received or found in any acquired allocation request information, and first personal identification information included in the corresponding printing data, and determines allocation details for putting a plurality of printing devices in charge for the not-yet-processed part of the printing data based on the second allocation request information with which the determination process is determined as to be executed. Based on the determined allocation details, the management-feature-provided printing device 7 also executes a printing process for the printing data stored in the data storage section 7c, or acquires the first allocation request information via a card reader. The details are left for later description.

The printing devices 4B′ and 4C′ receive the printing data coming from the management-feature-provided printing device 7, and take charge of the following operations. That is, the printing devices 4B′ and 4C′ subjected the received printing data to a printing process, acquires first allocation request information including second personal identification information, generates second allocation request information including second personal identification information based on the acquired first allocation request information, and transmits the resulting second allocation request information to the management-feature-provided printing device 7. In FIG. 12, the printing system 6 is provided with two printing devices of 4B′ and 4C′. The number of printing devices is not restricted, and one or zero, or three or more printing devices will do. The details will be described later.

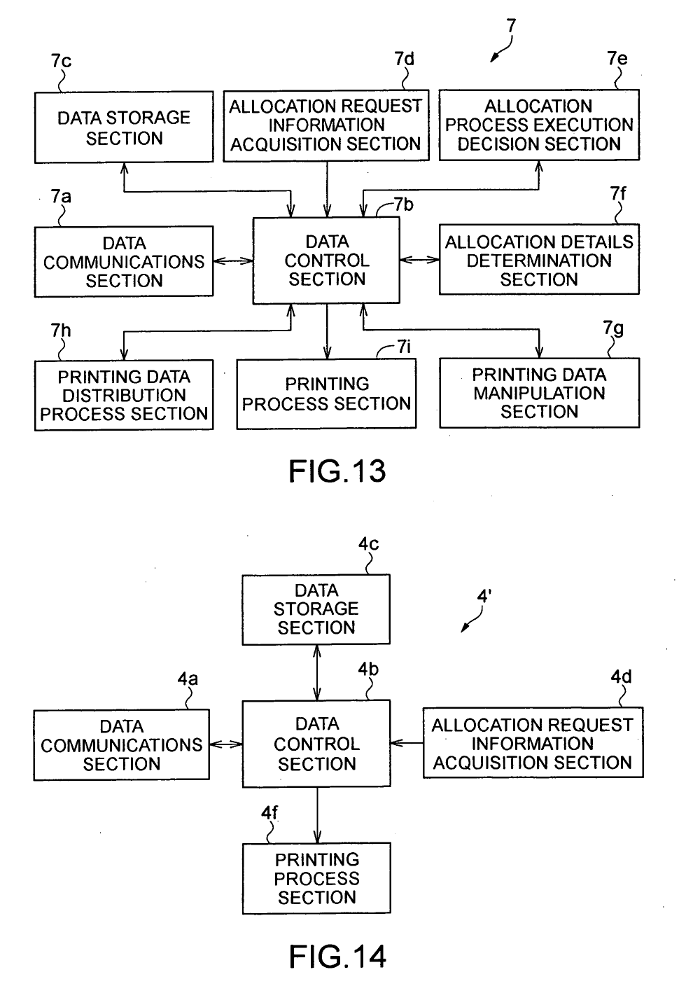

By referring to FIG. 13, described next is the detailed configuration of the management-feature-provided printing device 7. FIG. 13 is a block diagram showing the detailed configuration of the management-feature-provided printing device 7.

As shown in FIG. 13, the management-feature-provided printing device 7 is configured to include a data communications section 7a, a data control section 7b, a data storage section 7c, an allocation request information acquisition section 7d, an allocation process execution decision section 7e, an allocation details determination section 7f, a printing data manipulation section 7g, and a printing data distribution process section 7h.

The data communications section 7a serves to perform data transmission and reception with the devices connected over the network 5, e.g., receives printing data coming from the printing command device 2 over the network 5, receives second allocation request information coming from the printing device, or transmits the printing data manipulated in the printing data manipulation section 7g to the printing device.

The data control section 7b serves to collectively control the data flow in the management-feature-provided printing device 7. For example, the data control section 7b stores various types of data received from external devices such as the printing command devices 2A to 2C, the printing devices 4B′ and 4C′, and others via the data communications section 7a for storage into the data storage section 7c, forwards various data stored in the data storage section 7c to each corresponding components, relay controls data transmission and reception among the components, transmits the printing data to the printing device 4B′ or 4C′ via the data communications section 7a in response to a distribution command coming from the printing data distribution process section 7h, and transmits an acquisition request or others for capability information to the printing devices 4B′ and 4C′ via the data communications section 7a in response to a command coming from the allocation details determination section 7f.

The data storage section 7c serves to store the printing data, the second allocation request information, or others received via the data communications section 7a, and various other data needed for processing.

The allocation request information acquisition section 7d includes a card reader for magnetic cards, and an input panel. With the card reader, the information in a user's magnetic card can be read, and with the input panel, the allocation details can be set for a printing process. Such card information is hereinafter referred to as first allocation request information. When the first allocation request information is read by the card reader, based thereon, second allocation request information is generated for transmission to the allocation process execution decision section 7e via the data control section 7b. In the present embodiment, the first allocation request information includes second personal identification information for user authentication, and the allocation details can be set with the number of copies for the allocation destination. When a setting is made as such for the allocation number of copies through the input panel, the second allocation request information is generated in addition to the user information and information about the printing data. The second allocation request information includes the second personal identification information and the information about the number of printing copies. When no setting is made to the allocation number of copies, generated is the second allocation request information in addition to the user information and information about the printing data, including the second personal identification information, and the capability information in the management-feature-provided printing device 7 specifically for the printing process. In the present embodiment, with respect to the printing data currently in progress by any other printing device, the printing device 4 or the management-feature-provided printing device 7 that has read the magnetic data is authenticated as an allocation destination, and the second allocation request information is generated, including information telling that the printing device is the allocation destination.

The allocation process execution decision section 7e executes a user authentication process based on the first personal identification information included in the printing data, and the second personal identification information included in the second allocation request information. When the user is authenticated, a determination is then made that the allocation details determination section 7f subjects the allocation details to a determination process. When the user is not authenticated, on the other hand, it is determined that the allocation details are not subjected to the determination process. In the present embodiment, in the authentication process, a determination is made whether there is a match between the first personal identification information and the second personal identification information. When there is a match therebetween, the user is authenticated, and when there is no match therebetween, the user is not authenticated. For such an authentication process, such a matching between the first and second personal identification information is not the only option. Alternatively, a lookup table may be provided in advance to show correlation between the first and second personal identification information, e.g., the first personal identification information of “0034567” is correlated with the second personal identification information of “mokuya”. Using such a lookup table, the first personal identification information of “0034567” is checked against the second personal identification information of “mokuya”. With this being the case, when there is a match between the first and second personal identification information, it means that the user is authenticated, and when there is no match therebetween, it means that the user is not authenticated.

When the allocation process execution decision section 7e determines to execute the determination process, the allocation details determination section 7f analyzes the second allocation request information. Based on the analysis result, the allocation details are determined for the printing data corresponding to the second allocation request information. If the printing data corresponding to the second allocation request information is currently in the printing process, the allocation details are determined for the not-yet-completed part of the printing process for the printing data. The allocation details are determined based on the second allocation request information coming from the printing device being an allocation destination or from the allocation request information acquisition section 7d. In the present embodiment, when the second allocation request information includes information about the allocation number of copies, the allocation details are so determined that the allocation-destination printing device is allocated with the printing process for the number of copies based on the allocation number information irrespective of the capability information. On the other hand, when no setting is made to the allocation number of copies, the allocation details are determined based on the capability information in the second allocation request information. In the present embodiment, when the second allocation request information is acquired, if no printing device is in operation for the printing data corresponding thereto, the allocation details are so determined that the printing device designated as a transmission destination in the header information of the printing data is allocated with 100% of the printing process. That is, in the present embodiment, a determination process is executed for the allocation details also in the normal printing process instructed by the printing command device 2.

The printing data manipulation section 7g serves to generate manipulated printing data by manipulating the information in the header part of the printing data based on the allocation details determined in the allocation details determination section 7f. The generated manipulated printing data is forwarded to the printing device designated as an allocation destination of the manipulated printing device via the printing data distribution process section 7h. In the present embodiment, manipulating the printing data is of rewriting the header information based on the allocation details. Through such information rewriting, the allocation-destination printing device subjects the allocation number of copies to a printing process on a copy basis. The remaining number of copies is then counted, and the last manipulated printing data is provided with a message telling that the data is the last.

Based on the allocation details determined by the allocation details determination section 7f, the printing data distribution process section 7h serves to distribute the manipulated printing data generated by the printing data processing section 7g to the allocation-destination printing device via the data communications section 7a. Although the printing data manipulated by the printing manipulation section 7g is referred to as manipulated printing data in the present embodiment, the manipulated printing data has the same data configuration as the printing data to be generated by the printing command device 2. Therefore, no specific distinction will be made therebetween on the end of the printing device 4.

The management-feature-provided printing device 7 is provided with a processor, RAM (Random Access Memory), and ROM (Read Only Memory) storing a specific program, none of which are shown. By the processor executing the program, the components serve as programmed. As to the components, some serve as programmed only by the specific program, or some serve as programmed through control over the hardware by the specific program.

By referring to FIG. 14, described next is the detailed configuration of the printing devices 4B′ and 4C′. The printing devices 4B′ and 4C′ share the same capabilities and configuration, and when there is no need for specific distinction therebetween, a description is made collectively as the printing device 4′. FIG. 14 is a block diagram showing the detailed configuration of the printing device 4′.

As shown in FIG. 14, the printing device 4′ is configured to include the data communications section 4a, the data control section 4b, the data storage section 4c, the allocation request information acquisition section 4d, and the printing process section 4f. The printing device 4′ share the same capabilities and configuration as the printing device 4 of the first embodiment except that the printing device 4′ is not provided with the error information monitor section 4e, and the data control section 4b and the allocation request information acquisition section 4d both function partially differently.

The data control section 4b serves to collectively control the data flow in the printing command device 4. For example, the data control section 4b receives various types of data from the management-feature-provided printing device 7 via the data communications section 4a for storage into the data storage section 4c, forwards the data stored in the data storage section 4c to each corresponding components, relay controls data transmission and reception among the components, and transmits to the management-feature-provided printing device 7 various types of information in accordance with acquisition requests coming therefrom asking for the information.

Similarly to the allocation request information acquisition section 7d, the allocation request information acquisition section 4d includes a card reader for magnetic cards, and an input panel. With the card reader, the information in a user's magnetic card can be read, and with the input panel, the allocation details can be set for a printing process. Such card information is hereinafter referred to as first allocation request information. When the first allocation request information is read by the card reader, based thereon, second allocation request information is generated for transmission to the management-feature-provided printing device 7 via the data control section 4b and the data communications section 4a. In the present embodiment, the first allocation request information includes second personal identification information for user authentication, and the allocation details can be set with the number of copies for the allocation destination. When a setting is made to the allocation number of copies through the input panel, the second allocation request information is generated in addition to the user information and information about the printing data. The second allocation request information includes the second personal identification information and the information about the number of copies. When no setting is made to the allocation number of copies, generated is the second allocation request information in addition to the user information and information about the printing data, including the second personal identification information, and the capability information in the management-feature-provided printing device 7 specifically for the printing process.

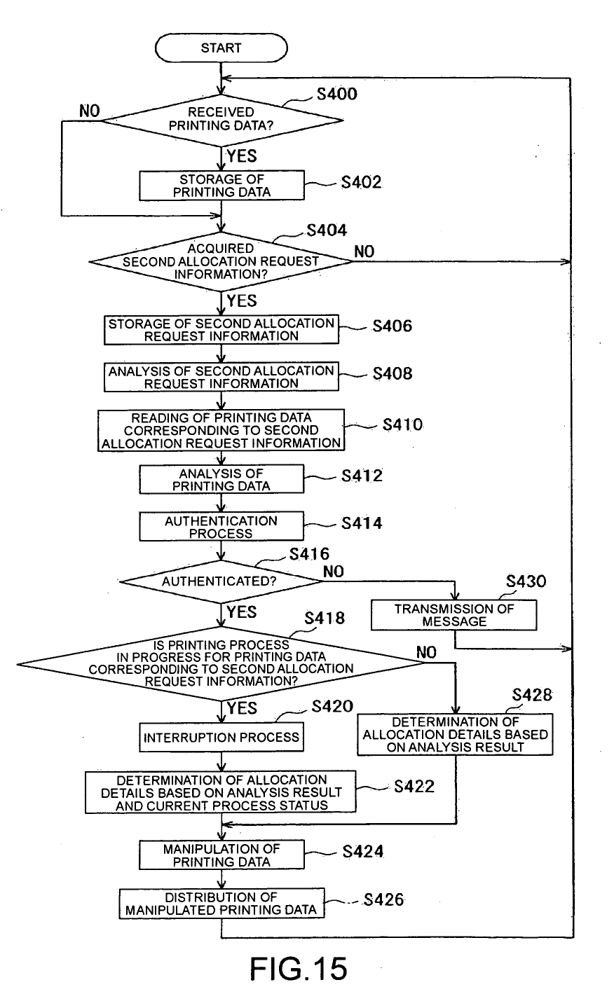

In the management-feature-provided printing device 7, the CPU starts a predetermined program stored in a predetermined region of the ROM, and in accordance with the program, executes a printing allocation process of the flowchart of FIG. 15.

FIG. 15 is a flowchart of a printing allocation process in the management.-feature-provided printing device 7.

As shown in FIG. 15, when the CPU starts executing the printing allocation process, the procedure first goes to step S400.

In step S400, in the data control section 7b, a determination is made whether the printing data is provided by the printing command devices 2A to 2C. When the printing data is determined as being provided (Yes), the procedure goes to step S402, and when not (No), the procedure goes to step S404.

In step S402, in the data control section 7b, the printing data received in step S400 is stored in the data storage section 7c, and the procedure then goes to step S404.

In step S404, in the data control section 7b, a determination is made whether second allocation request information is provided. When the second allocation request information is determined as being provided (Yes), the procedure goes to step S406, and when not (No), the procedure goes to step S400.

In step S406, in the data control section 7b, the second allocation request information acquired in step S404 is stored in the data storage section 7c, and the procedure then goes to step S408.

In step S408, in the data control section 7b, the second allocation request information stored in step S406 is analyzed, and the procedure then goes to step S410. Here, analyzing the second allocation request information is a process of extracting information from the second allocation request information, including information about allocation-destination printing devices, information about printing data in charge, e.g., user name, data title, or others, the second personal identification information, information about the allocation number of copies, capability information for the printing process, or others.

In step S410, based on the analysis result derived in step S408, in the data control section 7b, the printing data corresponding to the second allocation request information is read from the data storage section 7c via the data control section 7b. The procedure then goes to step S412.

In step S412, in the data control section 7b, the printing data read in step S410 is analyzed, and the procedure then goes to step S414. Here, analyzing the printing data is a process of extracting the first personal identification information included in the printing data.

In step S414, in the allocation process execution decision section 7e, an authentication process is executed based on the second personal identification information extracted through analysis in step S408, and the first personal identification information extracted through analysis in step S412. The procedure then goes to step S416.

In step S416, based on the authentication result derived in step S414, in the data control section 7b, a determination is made whether the user who has transmitted the allocation request information is authenticated or not. When the user is determined as being authenticated (Yes), the allocation details are allowed to be subjected to a determination process, and the procedure goes to step S418. When the user is not determined as being authenticated (No), the allocation details are not allowed to be subjected to the determination process, and the procedure goes to step S430.

In step S418, in the data control section 7b, a determination is made whether the printing data corresponding to the second allocation request information is in the printing process. When the printing data is determined as being in the printing process (Yes), the procedure goes to step S420, and when not (No), the procedure goes to step S428.

In step S420, in the data control section 7b, the printing process currently in progress for the printing data is interrupted, and the procedure goes to step S422. In the present embodiment, the printing process is interrupted in a similar manner to the first embodiment.

In step S422, based on the analysis results derived in steps S408 and S412, and the current process status, in the allocation details determination section 7f, a determination is made about the allocation details for the printing process, i.e., for the not-yet-completed part of the printing process for the printing data. The procedure then goes to step S424.

In step S424, based on the allocation details determined by the allocation details determination section 7f, in the printing data manipulation section 7g, the printing data read in step S410 is manipulated so that the manipulated printing data is generated. The procedure then goes to step S426. In the present embodiment, manipulating the printing data is a process of rewriting the header information based on the allocation details. Through such information rewriting, allocation-destination printing device subjects the allocation number of copies to a printing process on a copy basis, and the information in the header indicating the number of the printing copies always shows 1. The manipulated printing data is transmitted to the printing data distribution process section 7h while the remaining number of copies is counted, and the last manipulated printing data is provided with a message telling that the data is the last.

In step S426, in the printing data distribution process section 7h, the manipulated printing data generated by the printing data manipulation section 7g is distributed to the allocation-destination printing device via the data control section 7b and the data communications section 7a. The procedure then goes to step S400.

In step S418, when the printing data corresponding to the second allocation request information is not in the printing process, and when the procedure jumps to step S428, in the allocation details determination section 7f, a determination is made about the allocation details for the printing process, i.e., for the not-yet-completed part of the printing process for the printing data, based on the analysis results derived in steps S408 and S412. The procedure then goes to step S424.

In step S416, when the procedure goes to step S430 without authentication, in the data control section 7b, a message of rejecting the printing process is forwarded to the printing device being the transmission source of the second allocation request information, and the procedure goes to step S400. Herein, when the management-feature-provided printing device 7 is the transmission source of the second allocation request information, such a message is displayed in a display section that is not shown.

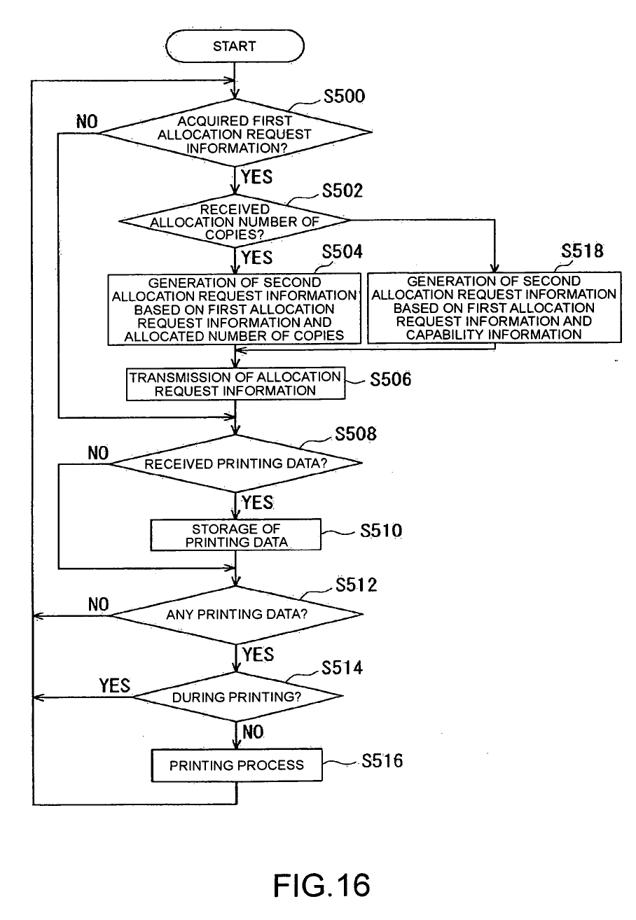

In the printing device 4′, the CPU starts a predetermined program stored in a predetermined region in the ROM, and in accordance with the program, a printing process of the flowchart of FIG. 16 is accordingly executed.

FIG. 16 is a flowchart of a printing process in the printing device 4′.

As shown in FIG. 16, after the CPU starts executing the printing process, the procedure first goes to step S500.

In step S500, in the allocation request information acquisition section 4d, a determination is made whether first allocation request information is acquired. When the first allocation request information is determined as being acquired (Yes), the procedure goes to step S502, and when not (No), the procedure goes to step S508.

In step S502, in the allocation request information acquisition section 4d, a determination is made whether an input is made for the allocation number of copies. When the allocation number of copies is determined as being input (Yes), the procedure goes to step S504, and when not (No), the procedure goes to step S518.

In step S504, in the allocation request information acquisition section 4d, second allocation request information is generated based on the first allocation request information acquired in step S500, and the allocation number of copies input in step S502. The procedure then goes to step S506.

In step S506, in the data control section 4b, the second allocation request information generated by the allocation request information acquisition section 4d is forwarded to the management-feature-provided printing device 7 via the data communications section 4a. The procedure then goes to step S508.

In step S508, in the data control section 4b, a determination is made whether the printing data is received from the management-feature-provided printing device 7 via the data communications section 4a. When the printing data is determined as being received (Yes), the procedure goes to step S510, and when not (No), the procedure goes to step S512.

In step S510, in the data control section 4b, the printing data received in step S508 is stored in the data storage section 4c, and the procedure goes to step S512.

In step S512, in the data control section 4b, a determination is made whether the data storage section 4c carries therein any not-yet-processed printing data. When such printing data is determined as being found (Yes), the procedure goes to step S514, and when not (No), the procedure goes to step S500.

In step S514, in the data control section 4b, a determination is made whether the printing process section 4f is currently in operation. When the printing process section 4f is determined as being in operation (Yes), the procedure goes to step S500, and when not (No), the procedure goes to step S516.

In step S516, in the printing process section 4f, the not-yet-processed printing data is read from the data storage section 4c via the data control section 4b. The read printing data is subjected to the printing process, and the procedure then goes to step S500.

In step S502, in the allocation request information acquisition section 4d, when the procedure goes to step S518 with no input is made for the allocation number of copies, the capability information is read from the data storage section 4c via the data control section 4b, and the second allocation request information is generated based on the capability information and the first allocation request information acquired in step S500. The procedure then goes to step S506.

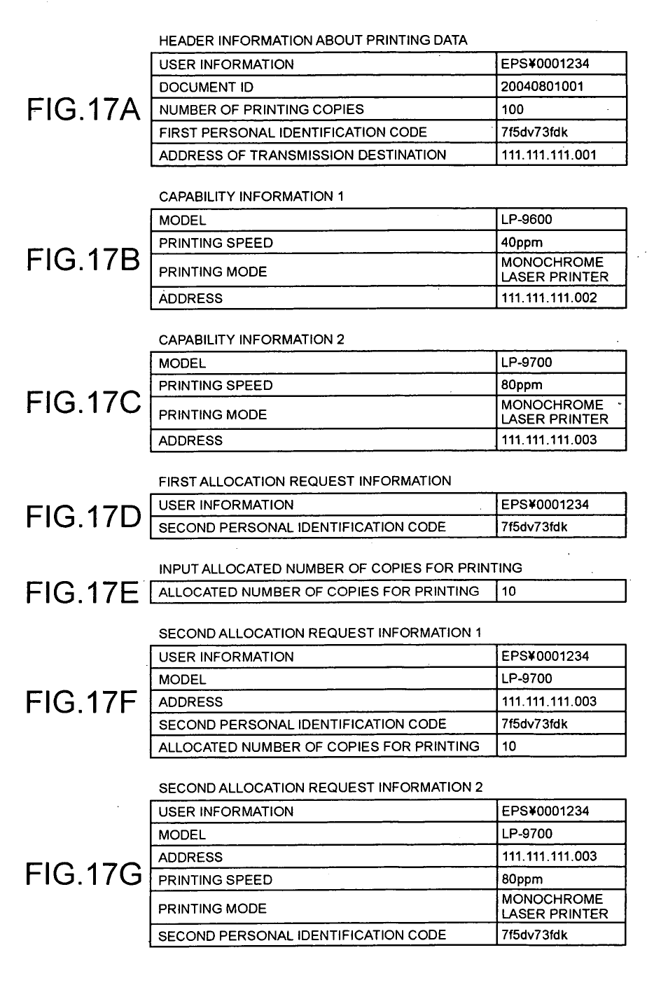

By referring to FIGS. 17A to 19C, described next is the operation in the present embodiment.

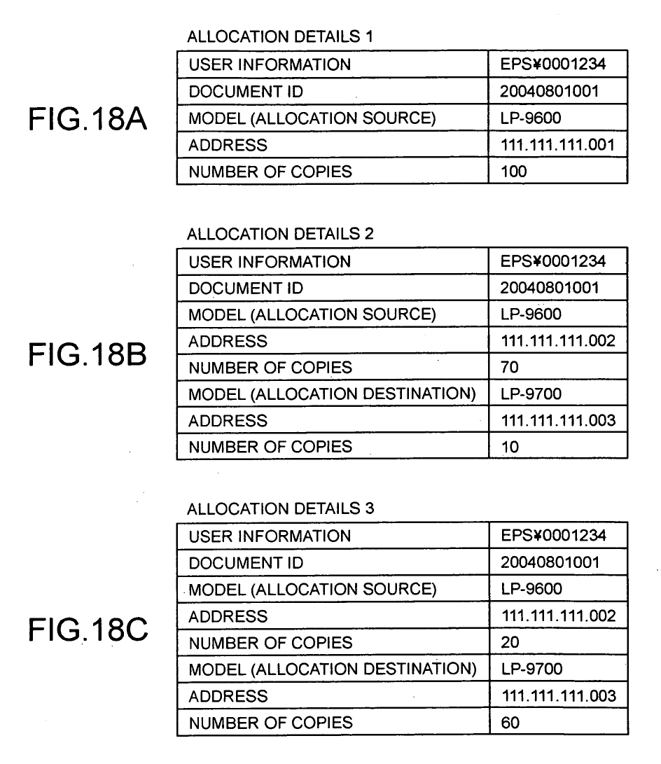

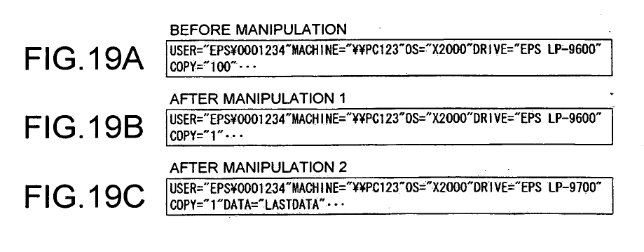

FIGS. 17A is a diagram showing exemplary information to be extracted by an analysis process for the printing data, FIG. 17B is a diagram showing exemplary capability information of the management-feature-provided printing device 7, FIG. 17C is a diagram showing exemplary capability information of the printing device 4c′, FIG. 17D is a diagram showing exemplary first allocation request information, FIG. 17E is a diagram showing exemplary allocation number of copies coming through an input panel, FIG. 17F is a diagram showing exemplary second allocation request information when a setting is made to the allocation number of copies, and FIG. 17G is a diagram showing exemplary second allocation request information when no setting is made to the allocation number of copies. FIGS. 18A to 18C are all diagrams showing exemplary allocation details to be determined by the allocation details determination section 7f. FIG. 19A is a diagram showing exemplary header information of printing data before the allocation details are determined, and FIGS. 19B and 19C are both diagrams showing exemplary header information of printing data manipulated based on the allocation details.

When the management-feature-provided printing device 7 receives printing data coming from the printing command device 2 via the data communications section 7a (step S400), the received printing data is stored in the data storage section 7c (step S402). In the present embodiment, as shown in FIG. 17A, the printing data coming from the printing command device 2 includes, in the header information, “EPS0001234” as user information, “20040801001” as document ID, “100” as number of printing copies, “7f5dv73fdk” as first personal identification information, and “111. 111. 111. 001” as address of transmission destination. Herein, the printing device having the address of transmission destination “111. 111. 111. 001” is the management-feature-provided printing device 7.

The user brings his or her magnetic card to the place where the management-feature-provided printing device 7 is located to issue a printing command thereto. The magnetic card is written with user information for use for user authentication, and second personal identification information for authentication. The user then makes the card reader of the management-feature-provided printing device 7 read the magnetic card. That is, in allocation-destination printing devices, the user information and the second personal identification information are read as the first allocation request information. In the present embodiment, as shown in FIG. 17D, the user makes the management-feature-provided printing device 7 read, as the first allocation request information, the user information of “EPS0001234”, and the second personal identification information of “7f5dv73fdk” written in the magnetic card.

As described above, in the management-feature-provided printing device 7, when the allocation request information acquisition section 7d acquires the first allocation request information via the card reader, the first allocation request information is used as a basis to generate the second allocation request information, telling that the management-feature-provided printing device 7 is the only allocation destination (step S404). After the second allocation request information is generated as such, the second allocation request information is stored in the data storage section 7c (step S406), and analyzed (step S408). Based on the analysis result, the printing data corresponding to the second allocation request information is read from the data storage section 7c (step S410). Thereafter, the printing data is analyzed (step S412), and a comparison is made between the first authentication information extracted through analysis, and the second personal identification information derived through analysis of the second allocation request information. Through such a comparison, a determination is made whether there is a match therebetween (step S414). In this example, there is a match between the second personal identification information of “7f5dv73fdk” in the second allocation request information, and the first personal identification information of “7f5dv73fdk” in the printing data corresponding to the user information “EPS0001234”. Therefore, the allocation details are allowed to be subjected to a determination process (step S416). The printing data corresponding to the user information “EPS0001234” is not currently in the printing process so that the allocation details determination section 7f determines the allocation details based on the second allocation request information and the analysis result of the printing data. With this being the case, the management-feature-provided printing device 7 is the only allocation destination, and as shown in FIG. 18A, determined here are the allocation details telling that the management-feature-provided printing device 7 is the only allocation destination (step S428). Once the allocation details are determined as such, in the printing data manipulation section 7g, a manipulation process is executed for the printing data based on the allocation details determined by the allocation details determination section 7f (step S424). In the present embodiment, as shown in FIG. 19A, the description of “COPY=“100”” indicating the number of printing copies in the header information of the not-yet-manipulated printing data is changed as “COPY=“1”” as shown in FIG. 19B so that the manipulated printing data is generated. The resulting manipulated printing data is repeatedly forwarded to a printing process section 7i via the printing data distribution process section 7h until the 100 copies are through with printing (step S426) Upon reception of the manipulated printing data coming via the printing data distribution process section 7h, the printing process section 7i accordingly executes a printing process to the acquired manipulated printing data.

Other than the management-feature-provided printing device 7 designated as a destination of a printing command, when the user finds any available printing device 4′ that is not currently in operation, the user makes the card reader of the printing device 4′ read the magnetic card. In the present embodiment, the printing device 4C′ presumably reads the magnetic card. That is, the printing device 4C′ is the one read the user identification information and the second personal identification information of FIG. 17D. Once the magnetic card is read as such, the user then inputs the allocation number of to an input panel that is not shown but provided to the printing device 4C′. In the present embodiment, as shown in FIG. 17E, the user is assumed as inputting 10 for the allocation number of copies to the printing device 4C′ through the input panel.

As described above, in the printing device 4c′, the allocation request information acquisition section.4d acquires the first allocation request information via the card reader (step S500). When an input is made through the input panel for the allocation number of copies (step S502), such second allocation request information as shown in FIG. 17F is generated (step S504). Such information generation is based on the acquired first allocation request information, the provided allocation number of copies, information about the printing device 4C′, e.g., model, IP address, and others. That is, as shown in FIG. 17F, the second allocation request information includes “EPS0001234” as user information, “LP-9700” as model, “111. 111. 111. 003” as IP address, “7f5dv73fdk” as second personal identification information, and “10” as allocation number of copies. The resulting second allocation request information is then forwarded to the management-feature-provided printing device 7 via the data communications section 4a (step S506).

When the second allocation request information comes from the printing device 4C′, the management-feature-provided printing device 7 receives the second allocation request information via the data communications section 7a (step S404). In the data control section 7b, the received second allocation request information is stored in the data storage section 7c (step S406), and the second allocation request information is analyzed (step S408). As a result of such analysis, the user information is extracted so that the printing data corresponding to the user information is read from the data storage section 7c (step S410) The read printing data is then analyzed (step S412), and in the allocation process execution decision section 7e, a determination is made whether there is a match between the first personal identification information extracted through analysis, and the second personal identification information extracted through analysis of the second allocation request information (step S414). Such a determination is made through a comparison therebetween. In this example, there is a match between the second personal identification information of “7f5dv73fdk” in the second allocation request information, and the first personal identification information of “7f5dv73fdk” of the printing data corresponding to the user information of “EPS0001234”. Therefore, the allocation process execution decision section 7e allows the allocation details to be subjected to a determination process (step S416). Here, the printing data corresponding to the user information “EPS0001234” is currently in the printing process in the management-feature-provided printing device 7. Thus, in the allocation details determination section 7f interrupts the printing process so that the process status is acquired (step S420). Assume that the second allocation request information is received in a process of printing 100 copies. In this case, when the second allocation request information is received, if printing of the 20th copy is halfway through, the printing process will be interrupted after the printing of the 20th copy is completed. The printing data may be discarded. If this is the case, as the process status, 20 copies are through with printing, but 80 copies are not yet printed. The allocation details determination section 7f thus determines the allocation details based on this process status, the analysis result of the second allocation request information, and the analysis result of the printing data (step S422). In this case, the second allocation request information includes “10” as the allocation printing number information. As shown in FIG. 18B, in the allocation details, the printing device 4C′ is thus allocated with 10 copies out of the remaining 80 copies, and the management-feature-provided printing device 7 with 70 copies. When the allocation details are determined as such, the printing data manipulation section 7g subjects the printing data to a manipulation process based on the allocation details determined by the allocation details determination section 7f (step S424) In the present embodiment, the remaining number of copies is changed from 80 to 70 in the management-feature-provided printing device 7, and the remaining number of copies is newly set to 10 in the printing device 4C′. As shown in FIG. 19B, the manipulated printing data in which the description for the number of copies in the header information is changed to “COPY=“1”” is repeatedly transmitted to the printing process section 7i via the printing data distribution process section 7h until the printing copies of 70 is completely through with printing. Such manipulated printing data, is also repeatedly distributed to the printing device 4C′ until the remaining number of copies 10 is through with printing (step S426). The printing data manipulation section 7g is counting the remaining number of copies every time the manipulated printing data is distributed, e.g., a setting value is decremented by 1 for every data distribution. When the counting value reaches 1, as shown in FIG. 19C, the header information is added with the description of DATA=“LASTDATA” so that the manipulated printing data is generated. This resulting manipulated printing data is forwarded to the corresponding printing device via the printing data distribution process section 7h. When the printing process section 7i receives the manipulated printing data coming via the printing data distribution process section 7h, the manipulated printing data is subjected to the printing process. When the printing device 4c′ receives the manipulated printing data coming from the management-feature-provided printing device 7 via the data communications section 4a (step S508), the data control section 4b stores the printing data in the data storage section 4c (step S510). In the printing process section 4f, when no printing data is currently in the printing process (step S514), the received printing data is subjected to the printing process therein (step S516).

Exemplified here is a case where, similarly to the above, the user uses the printing command device 2 to issue a printing command with respect to the management-feature-provided printing device 7, and selects the printing device 4C′ as an allocation destination. In such a case, described here is an exemplary operation when no input is made to the printing device 4C′ for the allocation number of copies.

With this being the case, as described in the foregoing, when the allocation request information acquisition section 4d acquires the first allocation request information comes via a card reader (step S500), no input is made for the allocation number of copies (step S502). Accordingly, such second allocation request information as shown in FIG. 17G is generated based on the acquired first allocation request information, the capability information stored in the data storage section 4c, and the information about the printing device 4C′, i.e., model and. IP address (step S518). That is, as shown in FIG. 17G, the second allocation request information includes “EPS0001234” as user information, “LP-9700” as model, “111. 111. 111. 003” as IP address, “80 ppm” as printing speed, “monochrome laser printer” as printing model, and “7f5dv73fdk” as second personal identification information. The generated second allocation request information is forwarded to the management-feature-provided printing device 7 via the data communications section 4a (step S506).

When the management-feature-provided printing device 7 receives the second allocation request information from the printing device 4C′ (step S404), similarly to the above, the authentication process is executed based on the first personal identification information found in the printing data, and the second personal identification information found in the second allocation request information (step S414). When the user is authenticated (step S416), the allocation details determination section 7f determines the allocation details based on the analysis result of the second allocation request information, and the analysis result of the printing data, i.e., the capability information of the-management-feature-provided printing device 7, and the capability information of the printing device 4C′. Exemplified here is a case, similarly to the above, where the not-yet-completed number of copies is 80, and the management-feature-provided printing device 7 operates with the printing speed of “40 ppm”, and the printing device 4C′ with “80 ppm”. Accordingly, as shown in FIG. 18C, the printing device 4C′ faster in printing speed than the management-feature-provided printing device 7 is put in charge of 60 copies, and the management-feature-provided printing device 7 is put in charge of 20 copies. As such, when no setting is made to the allocation number of copies, the allocation details determination section 7f determines the allocation details based on the performance capabilities of the printing devices.

Only such a simple operation as making a printing device read information written in a magnetic card, i.e., user information and document ID, enables the parallel processing. More in detail, a magnetic card is provided, for data reading, to a printing device that is separately provided from a printing device that is currently in a printing process for the printing data. This enables parallel processing for the not-yet-completed part of the printing process between the printing device currently in the printing process, and the printing device that has read the magnetic card.

What is more, for allocating the printing process to a printing device that is separately provided from a printing device currently in a printing process, the allocation-destination printing device is allowed to accept an input of the number of printing copies through an input panel. With such a configuration, out of the not-yet-completed part of the printing process of the printing data, any desired number of copies can be allocated to the allocation-destination printing device.

Moreover, in the management-feature-provided printing device 7, the printing data is manipulated based on the allocation details so that the manipulated printing data is generated, i.e., the allocation-destination printing device accordingly executes a printing process on a copy basis. The generated manipulated printing data is repeatedly distributed to the allocation-destination printing device for the allocation number of printing copies. In such a manner, the management-feature-provided printing device 7 can easily grasp the printing status of the allocation-destination printing device.

In the above second embodiment, the process and the allocation request information acquisition section 7d of receiving the second allocation request information from the printing device 4′ via the data communications section 7a and the data control section 7b, and storing the received second allocation request information in the data storage section 7c are corresponding to the allocation request information acquisition unit of the sixth or sixteenth aspect. The process of receiving the second allocation request information including the capability information from the printing device 4′ via the data communications section 7a and the data control section 7b, and storing the received second allocation request information in the data storage section 7c is corresponding to the capability information acquisition unit of the ninth or nineteenth aspect. The process of receiving the second allocation request information including the allocation number information from the printing device 4′ via the data communications section 7a and the data control section 7b, and storing the received second allocation request information in the data storage section 7c is corresponding to the specification information acquisition unit of the tenth or twentieth aspect.

Also in the above second embodiment, the process of acquiring the printing data corresponding to the second allocation request information from the data storage section 7c is corresponding to the allocation printing data acquisition unit of the sixth or sixteenth aspect. The allocation process execution decision section 7e is corresponding to the allocation details determination process execution decision unit of the seventh or seventeenth aspect. The allocation details determination section 7f is corresponding to the allocation details determination unit of any one of the sixth to tenth aspects, and the sixteenth to twenties aspects. The printing data manipulation section 7g is corresponding to the printing data manipulation unit of the sixth or sixteenth aspect. The process of distributing the manipulated printing data by the printing data distribution process section 7h, the data control section 7b, and the data communications section 7a is corresponding to the manipulated printing data transmission unit of the sixth or sixteenth aspect.

Also in the above second aspect, the process of receiving the printing data (manipulated printing data included) from the management-feature-provided printing device 7 via the data communications section 4a and the data control section 4b, and storing the received printing data in the data storage section 4c is corresponding to the printing data acquisition unit of the sixth or twenty-second aspect. The printing process section 4f is corresponding to the printing process unit of the sixth or twenty-second aspect, and the allocation request information acquisition section 4d is corresponding to the allocation request information input unit of the twenty-second aspect.

Also in the above second embodiment, steps S404 and S406 correspond to the capability information acquisition step of the thirty-third or fifty-first aspect, the allocation request information acquisition step of the thirtieth or forty-eighth aspect, or the specification information acquisition step of the twenty-first or thirty-first aspect. Steps S400 and S402 correspond to the printing data acquisition step of the thirtieth or fifty-eighth aspect. Step S414 corresponds to the allocation details determination process execution decision step of the thirty-first or forty-ninth aspect. Steps S416, S418, S420, S422, and S428 correspond to the allocation details determination step of any one of the thirtieth to thirty-fourth, and the forth-eighth to fifty-second aspects. Step S410 corresponds to the allocation printing data acquisition step of the thirtieth or forty-eighth aspect. Step S424 corresponds to the printing data manipulation step of the thirtieth or forty-eighth aspect. Step S426 corresponds to the manipulated printing data transmission step of the thirtieth or forty-eighth aspect.

Also in the above second embodiment, steps S500 and S502 correspond to the allocation request information input step of the forty-second or sixtieth aspect. Steps S504, S518, and S506 correspond to the allocation request information transmission step of the forty-second or sixtieth aspect. Steps, S512, S514, and S516 correspond to the printing process step of any one of the thirtieth, forty-second, forty-eighth, and sixtieth aspects.

Described in the first embodiment is the exemplary system configuration in which the printer server 3 includes the allocation details determination section 3d, the printing data manipulation section 3e, and the printing data distribution process section 3f. The printer server 3 takes charge of a distribution process of determining an allocation destination(s) and allocation details, and allocating the not-yet-completed printing job. On the other hand, described in the second embodiment is the exemplary system configuration in which the management-feature-provided printing device 7 includes the allocation process execution decision section 7e, the allocation details determination section 7f, the printing data manipulation section 7g, and the printing data distribution process section 7h. The management-feature-provided printing device 7 takes charge of the distribution process. Such system configurations are not the only options, and specifically for the allocation process, a printing management device A or B may be provided in the system. The printing management device A is configured to include the allocation details determination section 3d, the printing data manipulation section 3e, and the printing data distribution process section 3f. The printing management device B is configured to include the allocation process execution decision section 7e, the allocation details determination section 7f, the printing data manipulation section 7g, and the printing data distribution process section 7h.

With this being the configuration, when the printing management device A is used as an alternative to the printer server 3 in the first embodiment, the process of receiving the second allocation request information from the printing device, and storing the received second allocation request information in the data storage section of the printing management device A is corresponding to the allocation request information acquisition unit of the first or sixteenth aspect. The process of transmitting the acquisition request for the printing status information to the printing device 4 is corresponding to the acquisition request transmission unit of the twenty-first or twenty-second aspect. The process of receiving the printing status information from the printing device 4, and storing the received printing status information in the data storage section of the printing management device A is corresponding to the printing process status information acquisition unit of the first or sixteenth aspect. The process of analyzing the printing data coming from the printing command device 2, and transmitting the printing data to the transmission-destination printing device 4 is corresponding to the printing data transmission unit of the first or sixteenth aspect.

The process of receiving the error information from the printing device 4, and storing the received error information in the data storage section of the printing management device A is corresponding to the error information acquisition unit of the third or eighteenth aspect.

The process of transmitting the acquisition request for the capability information to the printing device 4, receiving the capability information from the printing device 4, and storing the received capability information in the data storage section of the printing management device A is corresponding to the capability information acquisition unit of the fourth or nineteenth aspect.

The process of acquiring the printing data corresponding to the second allocation request information from the data storage section of the printing management device A is corresponding to the allocation printing data acquisition unit of any one of the first to sixteenth aspects. The allocation details determination section 3d is corresponding to the allocation details determination unit of any one of the first to fifth, and the sixteenth to twentieth aspects. The printing data manipulation section 3e is corresponding to the printing data manipulation unit of the first or sixteenth aspect. The process of distributing the manipulated printing data by the printing data distribution process section 3f is corresponding to the manipulated printing data transmission unit of the first or sixteenth aspect.

Furthermore, steps S200 to S204 correspond to the capability information acquisition step of the twenty-eighth or forty-sixth aspect. Steps S214 and S216 correspond to the error information acquisition step of the twenty-seventh or forty-fifth aspect. Steps 220 and S222, and steps S236 and S238 correspond to the printing process status information acquisition step of the twenty-fifth or forty-third aspect. Steps S224, and S242 and S248 correspond to the allocation details determination step of any one of the twenty-fifth to twenty-ninth, and the forty-third to forty-seventh aspects. Step S230 corresponds to the allocation request information acquisition step of the twenty-fifth or forty-third aspect. Step S234 corresponds to the printing data acquisition step of the twenty-fifth or forty-third aspect. Steps S226 or S244 corresponds to the printing data manipulation step of the twenty-fifth or forty-third aspect. Step S228 or S246 corresponds to the manipulated printing data transmission step of the twenty-fifth or fifty-third aspect.

When the printing management device B is used as an alternative to the management-feature-provided printing device 7 in the second embodiment, the process and the allocation request information acquisition section 7d of receiving the second allocation request information from the printing device 4, and storing the received second allocation request information in the data storage section of the printing management device B is corresponding to the allocation request information acquisition unit of the first or sixteenth aspect. The process of receiving the second allocation request information including the capability information from the printing device 4, and storing the received second allocation request information to the data storage section of the printing management section B is corresponding to the capability information acquisition unit of the forth or nineteenth aspect. The process of receiving the second allocation request information including the allocation number information from the printing device 4, and storing the received second allocation request information in the data storage section of the printing management device B is corresponding to the specification information acquisition unit of the fifth or twentieth aspect.

The process of acquiring the printing data corresponding to the second allocation request information is corresponding to the allocation printing data acquisition unit of the first or sixteenth aspect. The allocation process execution decision section 7e is corresponding to the allocation details determination process execution decision unit of the second or seventeenth aspect. The allocation details determination section 7f is corresponding to the allocation details determination unit of any one of the first to fifth, and the sixteenth to twentieth aspects.

The printing data manipulation section 7g corresponds to the printing data manipulation unit of the eleventh or sixteenth aspect. The process of distributing the manipulated printing data by the printing data distribution process section 7h is corresponding to the manipulated printing data transmission unit of the first or sixteenth aspect.

Steps S404 and S406 correspond to the capability information acquisition step of the twenty-eighth or forty-sixth aspect, the allocation request information acquisition step of the twenty-fifth or forty-third aspect, or the specification information acquisition step of the twenty-ninth or forty-seventh aspect. Step S414 corresponds to the allocation details determination process execution decision step of the twenty-sixth or forty-fourth aspect. Steps S416, S418, S420, S422, and S428 correspond to the allocation details determination step of any one of the twenty-fifth to twenty-ninth, and the forty-third to forty-seventh aspects. Step S410 corresponds to the allocation printing data acquisition step of the twenty-fifth or forty-third aspect. Step S424 corresponds to the printing data manipulation step of the twenty-fifth or forty-third aspect. Step S426 corresponds to the manipulated printing data transmission step of the twenty-fifth or forty-third aspect.

In the above first and second embodiments, allocation of the printing process is made on a copy basis of the printing data. This is not restrictive, and the printing process may be allocated on a page basis.

In the above second embodiment, the printing data is provided with the first personal identification information, and the first allocation request information is provided with the second personal identification information. Using such personal identification information, an authentication process is executed to every printing device to determine whether the allocation details are to be subjected to a determination process. This is surely not restrictive, and an authentication process may be executed only to any needed printing devices, e.g., no authentication process is executed to a printing device to which a printing command is issued from the printing command device.

Exemplified here is a case with printing devices located in a specific department of an office. If a user issues a printing command to one of the printing devices, no authentication process is required to make printing outputs from the printing device or any other allocation-destination printing device(s) in the department. On the other hand, if a printing device located in another department is designated as an allocation destination, the authentication process is to be executed. In such a manner, when confidential documents are printed, the documents can be safely protected from peeking by people in the department.

In the first embodiment, the determined allocation details are used as a basis to rewrite the information about the number of printing copies in the header in consideration for the number of copies in the respective allocation destinations. The resulting manipulated printing data is forwarded to the printing data distribution process section. In the second embodiment, the information about the number of printing copies is rewritten to always indicate 1, and based on the determined allocation details, the resulting manipulated printing data is transmitted to the printing data distribution process section while the remaining number of copies is counted. With the last copy for printing, the manipulated printing data is transmitted together with such information. This is surely not restrictive, and any other manipulation method will be applicable, e.g., without counting or others, the manipulated printing data in which the header information indicates the number of copies of 1 is copied for the requiring number of copies.

In the above embodiments, for execution of the processes of the flowcharts of FIGS. 5 to 7, and 15 and 16, exemplified is a case of running the control program that is stored in the ROM in advance. This is surely not restrictive, and the procedure-storing program may be read from a storage medium into the RAM for execution.

Herein, the storage medium includes semiconductor recording medium such as RAM, ROM, and others, magnetic storage medium such as FD, HD, and others, storage medium of optical reading type media such as CD, CDV, LD, DVD, and others, and storage medium of magnetic/optical reading type such as MO and others. The storage medium is not restrictive to such types, i.e., electronic, magnetic, optical, and others, and any type will do as long as the medium is computer readable.

What is claimed is:

1. A printing management device that determines allocation details for a printing process in a system including a plurality of printing devices that execute the printing process based on printing data, the printing management device comprising:
an allocation request information acquisition unit that acquires allocation request information for the printing process, including information for specifying the printing data, and information about an allocation destination of the printing process;
a printing process status information acquisition unit that acquires, from any of the printing devices being in the printing process for the printing data, printing process status information that indicates a printing process status of the printing data;
an allocation printing data acquisition unit that acquires printing data corresponding to the allocation request information;
an allocation details determination unit that determines allocation details for a not-yet-completed part of the printing process based on the allocation request information and the printing process status information;
a printing data manipulation unit that manipulates the printing data derived by the allocation printing data acquisition unit based on the allocation details determined by the allocation details determination unit; and
a manipulated printing data transmission unit that transmits manipulated printing data as a result of manipulation of the printing data by the printing data manipulation unit to any of the printing devices being an allocation destination of the manipulated printing data.

2. The printing management device according to claim 1, wherein:
the printing data is uniquely correlated with first personal identification information,
the allocation request information includes second personal identification information that is unique thereto, and correlated with the first personal identification information,
an allocation details determination process execution decision unit that decides whether to subject the allocation details to a determination process based on the first and second personal identification information, and
when the allocation details determination process execution decision unit decides to subject the allocation details to the determination process, the allocation details determination unit executes the determination process.

3. The printing management device according to claim 1, further comprising:
an error information acquisition unit that acquires error information about an error occurred to any of the printing devices, and
based on the error information, the allocation details determination unit determines the allocation details to put any of the printing devices except the error-inflicted printing device in charge for the not-yet-completed part of the printing process.

4. The printing management device according to claim 1, further comprising:
a capability information acquisition unit that acquires capability information about performance capabilities of the printing devices, and
the allocation details determination unit determines the allocation details based on the capability information.

5. The printing management device according to claim 1, further comprising:
a specification information acquisition unit that acquires specification information about the number of printing copies for any of the printing devices that takes charge of the printing process for the printing data, and
the allocation details determination unit determines the allocation details based on the specification information about the number of printing copies.

6. A printing-management-feature-provided printing device, comprising:
an allocation request information acquisition unit that acquires allocation request information for a printing process, including information for specifying printing data, and information about an allocation destination of the printing process;
a printing process status information acquisition unit that acquires, from a printing device being in the printing process for the printing data, printing process status information that indicates a printing process status of the printing data;
an allocation printing data acquisition unit that acquires printing data corresponding to the allocation request information;
an allocation details determination unit that determines allocation details for a not-yet-completed part of the printing process based on the allocation request information and the printing process status information;
a printing data manipulation unit that manipulates the printing data derived by the allocation printing data acquisition unit based on the allocation details determined by the allocation details determination unit;
a manipulated printing data transmission unit that transmits manipulated printing data as a result of manipulation of the printing data by the printing data manipulation unit to a printing device being an allocation destination of the manipulated printing data;
a printing data acquisition unit that acquires the printing data;
a printing data storage unit that stores the printing data acquired by the printing data acquisition unit; and
a printing process unit that executes the printing process based on the printing data stored in the printing data storage unit.

7. The printing-management-feature-provided printing device according to claim 6, wherein:
the printing data is uniquely correlated with first personal identification information,
the allocation request information includes second personal identification information that is unique thereto, and correlated with the first personal identification information,
an allocation details determination process execution decision unit is included for making a decision whether to subject the allocation details to a determination process based on the first and second personal identification information, and
when the allocation details determination process execution decision unit decides to subject the allocation details to the determination process, the allocation details determination unit executes the determination process.

8. The printing-management-feature-provided printing device according to claim 6, further comprising:
an error information acquisition unit that acquires error information about an error occurred to the printing device, and
based on the error information, the allocation details determination unit determines the allocation details to put a printing device that is provided separately from the error-inflicted printing device in charge for the not-yet-completed part of the printing process.

9. The printing-management-feature-provided printing device according to claim 6, further comprising:
a capability information acquisition unit that acquires capability information about the printing devices, and
the allocation details determination unit determines the allocation details based on the capability information.

10. The printing-management-feature-provided printing device according to claim 6, further comprising:
a specification information acquisition unit that acquires specification information about the number of printing copies for the printing device that takes charge of the printing process for the printing data, and
the allocation details determination unit determines the allocation details based on the specification information about the number of printing copies.

11. A printing-management-feature-provided information processor, comprising:
an allocation request information acquisition unit that acquires allocation request information for a printing process that includes information for specifying printing data, and information about an allocation destination of the printing process;
a printing process status information acquisition unit that acquires, from a printing device being in the printing process for the printing data, printing process status information that indicates a printing process status of the printing data;
an allocation printing data acquisition unit that acquires printing data corresponding to the allocation request information;
an allocation details determination unit that determines allocation details for a not-yet-completed part of the printing process based on the allocation request information and the printing process status information;
a printing data manipulation unit that manipulates the printing data derived by the allocation printing data acquisition unit based on the allocation details determined by the allocation details determination unit;
a manipulated printing data transmission unit that transmits manipulated printing data as a result of manipulation of the printing data by the printing data manipulation unit to a printing device being an allocation destination of the manipulated printing data;
a printing data acquisition unit that acquires the printing data;
a printing data storage unit that stores the printing data acquired by the printing data acquisition unit; and
a printing data transmission unit that transmits the printing data stored in the printing data storage unit to the printing device that corresponds to the printing data.

12. A printing system that includes a plurality of printing devices each executing a printing process based on printing data, the system comprising:
an allocation request information acquisition unit that acquires allocation request information for the printing process, including information for specifying the printing data, and information about an allocation destination of the printing process;
a printing process status information acquisition unit that acquires, from any of the printing devices being in the printing process for the printing data, printing process status information that indicates a printing process status of the printing data;
an allocation printing data acquisition unit that acquires printing data corresponding to the allocation request information;
an allocation details determination unit that determines allocation details for a not-yet-completed part of the printing process based on the allocation request information and the printing process status information;
a printing data manipulation unit that manipulates the printing data derived by the allocation printing data acquisition unit based on the allocation details determined by the allocation details determination unit; and
a manipulated printing data transmission unit that transmits manipulated printing data as a result of manipulation of the printing data by the printing data manipulation unit to any of the printing devices being an allocation destination of the manipulated printing data.

13. A printing system, comprising:
the printing management device of claim 1; and
at least two of the printing devices, wherein:
the printing management device is connected to the printing devices for data communications,
the printing management device includes an acquisition request transmission unit that transmits an acquisition request to any of the printing devices for printing process status information, and
the printing devices each comprise:
a printing data acquisition unit that acquires printing data;
a printing data storage unit that stores the printing data acquired by the printing data acquisition unit;
a printing process unit that executes a printing process based on the printing data stored in the printing data storage unit;
an allocation request information input unit that inputs the allocation request information;
an allocation request information transmission unit that transmits, to the printing management device, the allocation request information input by the allocation request information input unit; and
a printing process status information transmission unit that transmits the printing process status information to the printing management device based on an acquisition request coming from the printing management device for the printing process status information.

14. A printing system, comprising:
the printing-management-feature-provided printing device of claim 6; and
at least one of the printing devices, wherein:
the printing-management-feature-provided printing device is connected to the printing device for data communications,
the printing-management-feature-provided printing device includes an acquisition request transmission unit that transmits an acquisition request to the printing device for printing process status information, and
the printing device includes:
a printing data acquisition unit that acquires printing data;
a printing data storage unit that stores the printing data acquired by the printing data acquisition unit;
a printing process unit that executes a printing process based on the printing data stored in the printing data storage unit;
an allocation request information input unit that inputs the allocation request information;
an allocation request information transmission unit that transmits, to the printing-management-feature-provided printing device, the allocation request information input by the allocation request information input unit; and
a printing process status information transmission unit that transmits the printing process status information to the printing-management-feature-provided printing device based on the acquisition request coming from the printing-management-feature-provided printing device for the printing process status information.

15. A printing system, comprising:
the printing-management-feature-provided information processor of claim 11; and
at least two of the printing devices, wherein:
the printing-management-feature-provided information processor includes an acquisition request transmission unit that transmits an acquisition request to any of the printing devices for printing process status information, and
the printing devices each include:
a printing data acquisition unit that acquires printing data;
a printing data storage unit that stores the printing data acquired by the printing data acquisition unit;
a printing process unit that executes a printing process based on the printing data stored in the printing data storage unit;
an allocation request information input unit that inputs the allocation request information;
an allocation request information transmission unit that transmits, to the printing-management-feature-provided information processor, the allocation request information input by the allocation request information input unit; and
a printing process status information transmission unit that transmits the printing process status information to the printing-management-feature-provided information processor based on the acquisition request coming from the printing-management-feature-provided information processor for the printing process status information.

16. A printing device, comprising:
a printing data acquisition unit that acquires printing data;
a printing data storage unit that stores the printing data acquired by the printing data acquisition unit;
a printing process unit that executes a printing process based on the printing data stored in the printing data storage unit;
an allocation request information input unit that inputs allocation request information about the printing process, including information for specifying the printing data, and information about an allocation destination of the printing process of the printing data;
an allocation request information transmission unit that transmits, to the printing management device, the allocation request information input by the allocation request information input unit; and
a printing process status information transmission unit that transmits the printing process status information to the printing management device based on an acquisition request coming from the printing management device for the printing process status information that indicates a printing process status of the printing data.

17. A printing management program that determines allocation details for a printing process in a system including a plurality of printing devices that execute the printing process based on printing data, the program comprises the steps of, for use with a computer:
acquiring allocation request information for the printing process that includes information for specifying the printing data, and information about an allocation destination of the printing process;
acquiring, from any of the printing devices being in the printing process for the printing data, printing process status information that indicates a printing process status of the printing data;
acquiring printing data corresponding to the allocation request information;
determining allocation details for a not-yet-completed part of the printing process based on the allocation request information and the printing process status information;
manipulating the printing data derived by the allocation printing data acquisition unit based on the allocation details determined in the allocation details determination step; and
transmitting manipulated printing data as a result of manipulation of the printing data in the printing data manipulation step to any of the printing devices being an allocation destination of the manipulated printing data.

18. A printing-management-feature-provided printing device control program that is used to control a printing-management-feature-provided printing device that determines allocation details for a printing process in a system including a plurality of printing devices that execute the printing process based on printing data, the program comprising the steps of, for use with a computer:
acquiring allocation request information for the printing process that includes information for specifying the printing data, and information about an allocation destination of the printing process;
acquiring, from any of the printing devices being in the printing process for the printing data, printing process status information that indicates a printing process status of the printing data;
acquiring printing data corresponding to the allocation request information;
determining allocation details for a not-yet-completed part of the printing process based on the allocation request information and the printing process status information;
manipulating the printing data derived by the allocation printing data acquisition unit based on the allocation details determined in the allocation details determination step;
transmitting manipulated printing data as a result of manipulation of the printing data in the printing data manipulation step to any of the printing devices being an allocation destination of the manipulated printing data;
acquiring the printing data;
storing the printing data acquired in the printing data acquisition step into a printing data storage unit; and
executing the printing process based on the printing data stored in the printing data storage step.

19. The printing-management-feature-provided printing device control program according to claim 18, further comprising:
a program for use with a computer to execute an acquisition request transmission step of transmitting an acquisition request about a printing process status to any of the printing devices.

20. A printing-management-feature-provided information processor control program that is used to control a printing-management-feature-provided information processor that determines allocation details for a printing process in a system including a plurality of printing devices that execute the printing process based on printing data, the program comprising the steps of, for use with a computer:
acquiring allocation request information for the printing process that includes information for specifying the printing data, and information about an allocation destination of the printing process;
acquiring, from any of the printing devices being in the printing process for the printing data, printing process status information that indicates a printing process status of the printing data;
acquiring printing data corresponding to the allocation request information;
determining allocation details for a not-yet-completed part of the printing process based on the allocation request information and the printing process status information;
manipulating the printing data derived by the allocation printing data acquisition unit based on the allocation details determined in the allocation details determination step;
transmitting manipulated printing data as a result of manipulation of the printing data in the printing data manipulation step to any of the printing devices being an allocation destination of the manipulated printing data;
acquiring the printing data;
storing the printing data acquired in the printing data acquisition step into a printing data storage unit; and
transmitting the printing data stored in the printing data storage unit to any of the printing devices corresponding to the printing data.

21. The printing-management-feature-provided information processor control program according to claim 20, further comprising:
a program for use with a computer to execute an acquisition request transmission step of transmitting an acquisition request about a printing process status to any of the printing devices.

22. A printing device control program, comprising the steps of, for use with a computer:
acquiring printing data;
storing the printing data acquired in the printing data acquisition step into a printing data storage unit;
executing a printing process based on the printing data stored in the printing data storage unit;
inputting allocation request information about the printing process, including information for specifying the printing data, and information about an allocation destination of the printing process of the printing data;
transmitting, to the printing management device, the allocation request information input by the allocation request information input step; and
transmitting the printing process status information to the printing management device based on an acquisition request coming from the printing management device for the printing process status information that indicates a printing process status of the printing data.

23. A printing management program that determines allocation details for a printing process in a system including a plurality of printing devices that execute the printing process based on printing data, the program comprises the steps of, for use with a computer:
acquiring allocation request information for the printing process that includes information for specifying the printing data, and information about an allocation destination of the printing process;
acquiring, from any of the printing devices being in the printing process for the printing data, printing process status information that indicates a printing process status of the printing data;
acquiring printing data corresponding to the allocation request information;
determining allocation details for a not-yet-completed part of the printing process based on the allocation request information and the printing process status information;
manipulating the printing data derived by the allocation printing data acquisition unit based on the allocation details determined in the allocation details determination step; and
transmitting manipulated printing data as a result of manipulation of the printing data in the printing data manipulation step to any of the printing devices being an allocation destination of the manipulated printing data.

24. A printing-management-feature-provided printing device control method that is used to control a printing-management-feature-provided printing device that determines allocation details for a printing process in a system including a plurality of printing devices that execute the printing process based on printing data, the method comprising the steps of:
acquiring allocation request information for the printing process that includes information for specifying the printing data, and information about an allocation destination of the printing process;
acquiring, from any of the printing devices being in the printing process for the printing data, printing process status information that indicates a printing process status of the printing data;
acquiring printing data corresponding to the allocation request information;
determining allocation details for a not-yet-completed part of the printing process based on the allocation request information and the printing process status information;
manipulating the printing data derived in the allocation printing data acquisition step based on the allocation details determined in the allocation details determination step;
transmitting manipulated printing data as a result of manipulation of the printing data in the printing data manipulation step to any of the printing devices being an allocation destination of the manipulated printing data;
acquiring the printing data; and
executing the printing process based on the printing data acquired in the printing data storage step.

25. The printing-management-feature-provided printing device control method according to claim 24, further comprising:
an acquisition request transmission step of transmitting an acquisition request about a printing process status to any of the printing devices.

26. A printing-management-feature-provided information processor control method that is used to control a printing-management-feature-provided information processor that determines allocation details for a printing process in a system including a plurality of printing devices that execute the printing process based on printing data, the program comprising the steps of:
acquiring allocation request information for the printing process that includes information for specifying the printing data, and information about an allocation destination of the printing process;
acquiring, from any of the printing devices being in the printing process for the printing data, printing process status information that indicates a printing process status of the printing data;
acquiring printing data corresponding to the allocation request information;
determining allocation details for a not-yet-completed part of the printing process based on the allocation request information and the printing process status information;
manipulating the printing data derived by the allocation printing data acquisition unit based on the allocation details determined in the allocation details determination step;
transmitting manipulated printing data as a result of manipulation of the printing data in the printing data manipulation step to any of the printing devices being an allocation destination of the manipulated printing data;
acquiring the printing data; and
transmitting the printing data acquired in the printing data acquisition step to any of the printing devices corresponding to the printing data.

27. The printing-management-feature-provided information processor control method according to claim 26, further comprising:
an acquisition request transmission step of transmitting an acquisition request about a printing process status to any of the printing devices.

28. A printing device control method, comprising the steps of:
acquiring printing data;
storing the printing data acquired in the printing data acquisition step into a printing data storage unit;
executing a printing process based on the printing data stored in the printing data storage unit;
inputting allocation request information about the printing process, including information for specifying the printing data, and information about an allocation destination of the printing process of the printing data;
transmitting, to the printing management device, the allocation request information input by the allocation request information input step; and
transmitting the printing process status information to the printing management device based on an acquisition request coming from the printing management device for the printing process status information that indicates a printing process status of the printing data.
